(19) United States
(12) Patent Application Publication
(10) Pub. No.: US 2016/0337334 A1
(43) Pub. Date: Nov. 17, 2016

(54) DEVICE, SYSTEM AND METHOD OF MOBILE IDENTITY VERIFICATION

(71) Applicant: Artz MURR, Beirut (LB)

(72) Inventor: Artz MURR, Beirut (LB)

(21) Appl. No.: 15/111,637

(22) PCT Filed: Jul. 3, 2014
(86) PCT No.: PCT/CA2014/000531

§ 371 Date: Jul. 14, 2016

Related U.S. Application Data
(60) Provisional application No. 62/008,312, filed on Jun. 5, 2014.

(30) Foreign Application Priority Data
Jan. 16, 2014 (LB) 10235

(51) Int. Cl. H04L 29/06; H04W 12/06

(52) U.S. Cl. CPC H04L 63/083; H04W 12/06; G06Q 30/0226

(57) ABSTRACT

A device, system and method of mobile identity verification is provided. Identifier data is received at the device, from a remote computing device. The device generates a machine-readable verification code using a first given algorithm, the first given algorithm configured to encode the identifier data in the verification code; data encoded in the verification code is extractable using a second given algorithm complimentary to the first given algorithm. The verification code is provided for acquisition by a proximal device for transmission to the remote computing device to provide a one-time verification of the device by extracting at least the identifier data from the verification code using the second given algorithm at the remote computing device. New identifier data is received when the verification code expires after one or more of a given time period and a given number of uses to generate a new verification code.

### FIELD

The present specification relates generally to mobile devices and specifically to a device, system and method of mobile identity verification.

### BACKGROUND

Mobile devices have become ubiquitous and are being used more frequently to complete data exchanges with computing devices. However, such data exchanges are generally performed without any verification whatsoever of the identity of the mobile device; rather entities and/or computing devices exchanging data with a mobile device inherently accept that the mobile device is authorized to exchange the data with the computing device. For example, a mobile device can be used for providing an indication of registration in a loyalty program by providing a barcode, and the like, at the device where a loyalty program registration number is encoded: as the barcode can easily be copied onto multiple devices, a computing device acquiring and/or reading the barcode has no way of verifying the identity of the mobile device to determine whether the mobile device is associated with the loyalty program.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts a system for mobile identity verification, according to non-limiting implementations.

FIG. 2 depicts a schematic diagram of a device of the system of FIG. 1, the device for providing a verification code, according to non-limiting implementations.

FIG. 3 depicts a schematic diagram of a device of the system of FIG. 1, the device for acquiring the verification code from the device of FIG. 2, according to non-limiting implementations.

FIG. 4 depicts a schematic diagram of a device of the system of FIG. 1, the device for verifying the identity of the device of FIG. 2, according to non-limiting implementations.

FIG. 5 depicts a method of mobile identity verification, according to non-limiting implementations.

FIG. 6 depicts receipt of password data at the device of FIG. 2, in the system of FIG. 1, according to non-limiting implementations.

FIG. 7 depicts generation of a verification code at the device of FIG. 2, according to non-limiting implementations.

FIG. 8 depicts the system of FIG. 1 with an amount of associated with a potential transaction being provided, according to non-limiting implementations.

FIG. 9 depicts the system of FIG. 1 with the verification code being presented for acquisition, according to non-limiting implementations.

FIG. 10 depicts decoding of the verification code by the device of FIG. 4, according to non-limiting implementations.

FIG. 11 depicts receipt of a password and the like at the system of FIG. 1, according to non-limiting implementations.

FIG. 12 depicts successful verification of identity of the device of FIG. 2, according to non-limiting implementations.

FIG. 13 depicts the device of FIG. 2 receiving new identification data, within the system of FIG. 1, after a verification code expires, according to non-limiting implementations.

FIG. 14 depicts a method of providing a secure keypad, according to non-limiting implementations.

FIG. 15 depicts a secure keypad being provided in the system of FIG. 1, according to non-limiting implementations.

FIG. 16 depicts data sets for providing a secure keypad, according to non-limiting implementations.

FIG. 17 depicts an alternative system for mobile identity verification, according to non-limiting implementations.

FIG. 18 depicts an alternative method of mobile identity verification, according to non-limiting implementations.

FIG. 19 depicts the system of FIG. 17 in the process of mobile identity verification, according to non-limiting implementations.

FIG. 20 depicts successful mobile identity verification in the system of FIG. 17, according to non-limiting implementations.

FIG. 21 depicts an alternative system of mobile identity verification, according to non-limiting implementations.

FIG. 22 depicts an alternative method of mobile identity verification, according to non-limiting implementations.

FIG. 23 depicts the method of FIG. 22 being implemented in the system of FIG. 21, according to non-limiting implementations.

FIG. 24 depicts an alternative system for mobile identity verification, according to non-limiting implementations.

FIG. 25 depicts an alternative method of mobile identity verification, according to non-limiting implementations.

FIG. 26 depicts initiation of identity verification occurring at the system of FIG. 24, according to non-limiting implementations.

FIG. 27 depicts successful mobile identity verification in the system of FIG. 24, according to non-limiting implementations.

FIG. 28 depicts an alternative system for mobile identity verification, according to non-limiting implementations.

FIG. 29 depicts an alternative method of mobile identity verification, according to non-limiting implementations.

FIG. 30 depicts successful mobile identity verification in the system of FIG. 28, according to non-limiting implementations.

### SUMMARY

In general, this disclosure is directed to devices, methods and systems of mobile identity verification, including identity verification of mobile devices. In some implementations, a remote computing device, such as a server with which a mobile device is registered, can send identifier data to the mobile device, for example upon receipt of a PIN (personal identifier number), and the like, in an application at the mobile device. The mobile device can generate a machine readable verification code using a given algorithm to encode the identifier data in the verification code and optionally a time stamp, and/or other data for identifying the mobile device that can be stored at the mobile device and/or generated by the mobile device. In specific non-limiting implementations, the verification code can comprise a QR (quick response) code and the like. Furthermore, once the identifier data is received, the mobile device can be off-line when generating and/or rendering the verification code; hence identity verification of the mobile device can occur while the mobile device is off-line. A proximal device can acquire and/or read the verification code when the verification code is rendered at a display of the mobile device, and transmit the verification code to the remote computing device; the remote computing device decodes the verification code using a complimentary algorithm. When data in the verification code, such as the identifier data, matches data stored at the remote computing device, and/or is confirmed as having been generated by and/or associated with the mobile device, the remote computing device can provide a verification of identity to the proximal device. If the verification code matches a previously received verification code, and/or if use of the verification code exceeds a given number of uses, and/or if the verification code has expired after a given time period and/or if the identifier data does not match identifier data stored at the remote computing device, a denial of verification is transmitted instead.

Similar alternative techniques are provided for identity verification, including techniques for verifying identity at websites, and the like, as well as techniques for verifying identity for data exchanges between mobile devices.

The present specification further provides a secure keypad that can be rendered at a touch screen display to receive a password and/or a PIN. A device rendering the keypad requests and receives data sets from a remote computing device, for example a matrix of data sets, the data sets provided in an associated one-to-one relationship with keys of the keypad. For example, a first data set is provided that is associated with a first key, a second data set is provided that is associated with a second key, etc. When the password and/or PIN is received at the keypad, the device transmits a subset of the data sets to the remote computing device that corresponds to an order of selection of the associated keys, rather than the password and/or PIN itself. Hence, if the transmission is intercepted by a malicious device and/or malware in an attempt to steal the password and/or PIN, only the subsets will be detected and the password and/or PIN will be secure. As a new matrix of data sets can be provided each time a password and/or PIN is requested, and/or each time the keypad is rendered, the malicious device cannot use pattern recognition in a plurality of transmitted subsets to discern the password and/or PIN. In some implementations, the keys of the keypad can be rendered in a random order.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

Furthermore, as will become apparent, in this specification certain elements may be described as connected physically, electronically, or any combination thereof, according to context. In general, components that are electrically connected are configured to communicate (that is, they are capable of communicating) by way of electric signals. According to context, two components that are physically coupled and/or physically connected may behave as a single element. In some cases, physically connected elements may be integrally formed, e.g., part of a single-piece article that may share structures and materials. In other cases, physically connected elements may comprise discrete components that may be fastened together in any fashion. Physical connections may also include a combination of discrete components fastened together, and components fashioned as a single piece.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XYY, YZ, ZZ, and the like). Similar logic can be applied for two or more items in any occurrence of “at least one . . . ” and “one or more . . . ” language.

An aspect of the specification provides a device comprising: a processor, a display, a memory and a communication interface, the processor configured to: receive, from a remote computing device using the communication interface, identifier data; generate a machine-readable verification code using a first given algorithm, the first given algorithm configured to encode the identifier data in the verification code; data encoded in the verification code being extractable from the verification code using a second given algorithm complimentary to the first given algorithm; provide the verification code for acquisition by a proximal device for transmission to the remote computing device to provide a one-time verification of the device by extracting at least the identifier data from the verification code using the second given algorithm at the remote computing device; and, receive, from the remote computing device using the communication interface, new identifier data to generate a new verification code when the verification code expires after one or more of a given time period and a given number of uses.

The processor can be further configured to provide the verification code by rendering the verification code at the display.

The processor can be further configured to provide the verification code by transmitting the verification code in a near field signal to the proximal device.

The verification code can comprise one or more of: a QR (Quick Response) code, a UPC (Universal Product Code), a graphic, an icon, and a symbol.

The data encoded in the verification code can be extractable from the verification code at the remote computing device using only the second given algorithm.

The first given algorithm can be further configured to encode, in the verification code, a device identifier stored at the memory.

The device can further comprise a clock device, wherein the first given algorithm can be further configured to encode, in the verification code, a time stamp from the clock device.

The first given algorithm can be further configured to: generate a one-time identifier of the device each time the verification code is generated, and encode the one-time identifier in the verification code, the second given algorithm further configured to extract the one-time identifier from the verification code and confirm that the one-time identifier was generated by the device.

The processor can be further configured to generate the one-time-use machine-readable verification code when the device is off-line.

The device can further comprise an input device, and processor can be further configured to request, from a remote computing device, the identifier data when password data is received at the input device.

The identifier data can expire after one or more of the given time period and the given number of uses.

The verification code can be generated in conjunction with one or more of a: further transaction between the proximal device and remote computing device, an exchange of payment data between the proximal device and remote computing device, and an exchange of loyalty plan data between the proximal device and remote computing device.

A further aspect of the specification provides a method comprising: at a device comprising: a processor, a display, a memory and a communication interface: receiving, at the processor, from a remote computing device using the communication interface, identifier data; generating, at the processor, a machine-readable verification code using a first given algorithm, the first given algorithm configured to encode the identifier data in the verification code; data encoded in the verification code being extractable from the verification code using a second given algorithm complimentary to the first given algorithm; providing, using the processor, the verification code for acquisition by a proximal device for transmission to the remote computing device to provide a one-time verification of the device by extracting at least the identifier data from the verification code using the second given algorithm at the remote computing device; and, receiving, at the processor, from the remote computing device using the communication interface, new identifier data to generate a new verification code when the verification code expires after one or more of a given time period and a given number of uses.

The method can further comprise providing the verification code by rendering the verification code at the display.

The method can further comprise providing the verification code by transmitting the verification code in a near field signal to the proximal device.

The verification code can comprise one or more of: a QR (Quick Response) code, a UPC (Universal Product Code), a graphic, an icon, and a symbol.

The data encoded in the verification code can be extractable from the verification code at the remote computing device using only the second given algorithm.

The first given algorithm can be further configured to encode, in the verification code, a device identifier stored at the memory.

The device can further comprise a clock device, and wherein the first given algorithm can be further configured to encode, in the verification code, a time stamp from the clock device.

The first given algorithm can be further configured to: generate a one-time identifier of the device each time the verification code is generated, and encode the one-time identifier in the verification code, the second given algorithm further configured to extract the one-time identifier from the verification code and confirm that the one-time identifier was generated by the device.

The method can further comprise generating the one-time-use machine-readable verification code when the device is off-line.

The device can further comprise an input device, and the method can further comprise requesting, from a remote computing device, the identifier data when password data is received at the input device.

The identifier data can expire after one or more of the given time period and the given number of uses.

The verification code can be generated in conjunction with one or more of a: further transaction between the proximal device and remote computing device, an exchange of payment data between the proximal device and remote computing device, and an exchange of loyalty plan data between the proximal device and remote computing device.

Yet a further aspect of the specification provides a device comprising: a processor, a touch-screen display, and a communication interface, the processor configured to: receive, using the communication interface, data sets from a remote computing device, each of the data sets associated with a given key of a keypad in a one-to-one relationship; render the keys of the keypad at the touch-screen display; receive, at the touch-screen display, input at the keys of the keypad corresponding to a selection of a subset of the keys in a particular order; and, transmit a subset of the data sets to the remote computing device in an order corresponding to a selection of associated keys of the subset for verification of the subset.

The processor can be further configured to render the keys of the keypad according to data received in the data sets.

The processor can be further configured to request, using the communication interface, the data sets from the remote computing device.

The processor can be further configured to randomly render the keys of the keypad.

The keys of the keypad can correspond to numbers in a range of 0 to 9.

The data sets can be provided in a matrix, and each position in the matrix can correspond to a respective key of the keypad.

Each of the data sets can comprise one or more of a digital picture, a randomly generated digital picture, data in a digital picture format, text data, and randomly generated text data.

The processor can be further configured to receive new data sets to replace the data sets one or more of: each time the keypad is rendered, and after each time the selection of the subset of the keys is received.

Each of the data sets can comprise data corresponding to a respective key, and the processor can be further configured to render the keys of the keypad according to the data corresponding to the respective key, in an order corresponding to an order of the data sets.

Another aspect of the specification provides a method comprising: at a device comprising a processor, a touch-screen display, and a communication interface, receiving, at the processor using the communication interface, data sets from a remote computing device, each of the data sets associated with a given key of a keypad in a one-to-one relationship; rendering, using the processor, the keys of the keypad at the touch-screen display; receiving, at the touch-screen display, input at the keys of the keypad corresponding to a selection of a subset of the keys in a particular order; and, transmitting, using the processor, a subset of the data sets to the remote computing device in an order corresponding to a selection of associated keys of the subset for verification of the subset.

The method can further comprise rendering the keys of the keypad according to data received in the data sets.

The method can further comprise requesting, using the communication interface, the data sets from the remote computing device.

The method can further comprise randomly rendering the keys of the keypad.

The keys of the keypad can correspond to numbers in a range of 0 to 9.

The data sets can be provided in a matrix, each position in the matrix can correspond to a respective key of the keypad.

Each of the data sets can comprise one or more of a digital picture, a randomly generated digital picture, data in a digital picture format, text data, and randomly generated text data.

The method can further comprise receiving new data sets to replace the data sets one or more of: each time the keypad is rendered, and after each time the selection of the subset of the keys is received.

Each of the data sets can comprise data corresponding to a respective key, and the method can further comprise rendering the keys of the keypad according to the data corresponding to the respective key, in an order corresponding to an order of the data sets.

Yet a further aspect of the specification provides a device comprising: a processor, and a communication interface, the processor configured to: receive, using one or more of the communication interface and an input device, an identifier of a mobile device; transmit, using the communication interface, the identifier to a second computing device to trigger the second computing device to transmit a one-time-use code to the mobile device; receive, using one or more of the communication interface and the input device, the one-time-use code; transmit the one-time-use code to the second computing device; and, receive an indication of verification from the second computing device in response to transmitting the one-time-use code thereto.

The processor can be further configured to transmit, to the second computing device with the identifier, one or more of transaction data, payment data, and loyalty plan data.

The indication of verification can include one or more of transaction data, payment data, and loyalty plan data.

The identifier can comprise one or more of a network address of the mobile device, and a phone number of the mobile device.

Another aspect of the specification provides a method comprising: at a device comprising a processor, and a communication interface, receiving, at the processor using one or more of the communication interface and an input device, an identifier of a mobile device; transmitting, using the communication interface, the identifier to a second computing device to trigger the second computing device to transmit a one-time-use code to the mobile device; receiving, at the processor using one or more of the communication interface and the input device, the one-time-use code; transmitting the one-time-use code to the second computing device; and, receiving an indication of verification from the second computing device in response to transmitting the one-time-use code thereto.

The method can further comprising transmitting, to the second computing device with the identifier, one or more of transaction data, payment data, and loyalty plan data.

The indication of verification can include one or more of transaction data, payment data, and loyalty plan data.

The identifier can comprise one or more of a network address of the mobile device, and a phone number of the mobile device.

Yet a further aspect of the specification provides a device comprising: a processor, a memory, and a communication interface, the processor configured to: receive, from a device, a network address of a communication device; transmit, to the communication device using the network address and the communication interface, a request for verification to trigger receipt of a verification code at the communication device; receive a verification code from the communication device in response to transmitting the request thereto; and, when the verification code matches data stored at the memory in association with an identifier of the communication device, transmit, to the device using the communication interface, a verification of identity of the communication device.

Yet a further aspect of the specification provides a method comprising: at a device comprising a processor, a memory, and a communication interface, receiving, at the processor from a second device, a network address of a communication device; transmitting, to the communication device using the network address and the communication interface, a request for verification to trigger receipt of a verification code at the communication device; receiving, at the processor, a verification code from the communication device in response to transmitting the request thereto; and, when the verification code matches data stored at the memory in association with an identifier of the communication device, transmit, to the second device using the communication interface, a verification of identity of the communication device.

Yet a further aspect of the specification provides a device comprising: a processor, an input device, a display, and a communication interface, the processor configured to: receive, from the input device, a network address of a communication device; transmit, using the communication interface, the network address to a remote computing device; in response, receive, from the remote computing device, using the communication interface, a digital picture associated with the communication device; render the digital picture at the display; and, in response, transmit, to the remote computing device, using the communication interface one of: a verification of the communication device and a rejection of the communication device.

Yet a further aspect of the specification provides a method comprising: at a device comprising a processor, an input device, a display, and a communication interface, receiving, from the input device, a network address of a communication device; transmitting, using the communication interface, the network address to a remote computing device; in response, receive, from the remote computing device, using the communication interface, a digital picture associated with the communication device; rendering the digital picture at the display; and, in response, transmitting, to the remote computing device, using the communication interface one of: a verification of the communication device and a rejection of the communication device.

Yet a further aspect of the specification provides a device comprising: a processor, and a communication interface, the processor configured to: receive, using the communication interface, a network address of a communication device and verification identification data associated with the communication device; generate a one-time code; transmit, to the communication device using the network address and the communication interface, the one-time code; and, transmit, to a computing device using the communication interface, the one-time code and the verification identification data along with data that triggers performance of a task so that when the one-time code transmitted to the communication device is provided to the computing device via the communication device, the task is performed.

Yet a further aspect of the specification provides a method comprising: at a device comprising a processor, and a communication interface, receiving, at the processor using the communication interface, a network address of a communication device and verification identification data associated with the communication device; generating, at the processor, a one-time code; transmitting, to the communication device using the network address and the communication interface, the one-time code; and, transmitting, to a computing device using the communication interface, the one-time code and the verification identification data along with data that triggers performance of a task so that when the one-time code transmitted to the communication device is provided to the computing device via the communication device, the task is performed.

### DETAILED DESCRIPTION

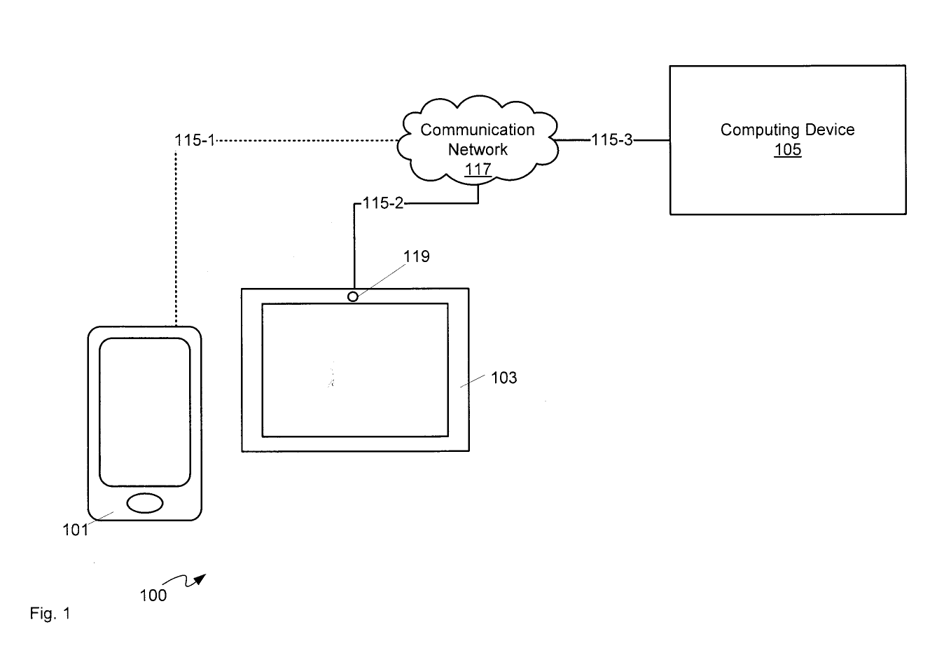

FIG. 1 depicts a system 100 for mobile identity verification comprising a mobile device 101, a computing device 103, and a remote computing device 105, in communication using respective links 115-1, 115-2, 115-3 to a communications network 117. Mobile device 101 will be interchangeably referred to hereafter as device 101; similarly, computing device 103 will be interchangeably referred to hereafter as device 103 and/or proximal device 103 as in present implementations device 103 is proximal to device 101 in data exchanges therewith; and similarly, remote computing device 105 will be interchangeably referred to hereafter as device 105. Furthermore, links 115-1, 115-2, 115-3 will be interchangeably referred to hereafter, collectively, as links 115, and generically as a link 115. Communication network 117 will be interchangeably referred to hereafter as network 117.

As described in further detail hereafter, device 101 is generally configured to: receive, from remote computing device 105, identifier data; generate a machine-readable verification code using a first given algorithm, the first given algorithm configured to encode, the identifier data in the verification code; data encoded in the verification code being extractable from the verification code using a second given algorithm complimentary to the first given algorithm; provide the verification code for acquisition by proximal computing device 103 for transmission to remote computing device 105 to provide a verification of device 101 by extracting at least the identifier data from the verification code using the second given algorithm at remote computing device 105; and receive, from remote computing device 105 new identifier data to generate a new verification code when the verification code expires after one or more of a given time period and a given number of uses. As depicted in FIG. 1, device 103 can comprise a camera device, an external portion 119 of the camera device depicted in FIG. 1 (such as a lens, an aperture and the like), the camera device used to acquire and/or read the verification code at a display of device 101. While current implementations are described with respect to the verification code comprising a graphical code, in alternative implementations, the verification code can be encoded in a near field signal and transmitted to device 103.

Such verification of device 101 can occur to verify the identity of device 101 in data exchanges with device 103, in conjunction with one or more of electronic transactions, electronic payments, electronic loyalty point credits, and general verification of identity of device 101. In some implementation, verification of identity of device 101 can occur in conjunction with data exchanges between device 103 and device 105, for example to trigger an electronic data exchange between an account associated with device 101 and an account associated with device 103. However, in yet further implementations, verification of identity of device 101 can occur when a user associated with device 103 is delivering a physical package, and the like, to a user of device 101: for example a courier delivering a package to a user of device 101 can use device 103 to verify an identity of device 101 prior to handing the package to the user of device 101.

It is further appreciated that verifying identity of a device can include verifying that given device is associated with a given network address, verifying that given data originated at a given device, verifying that a given device is associated with given data and/or a given user, and the like.

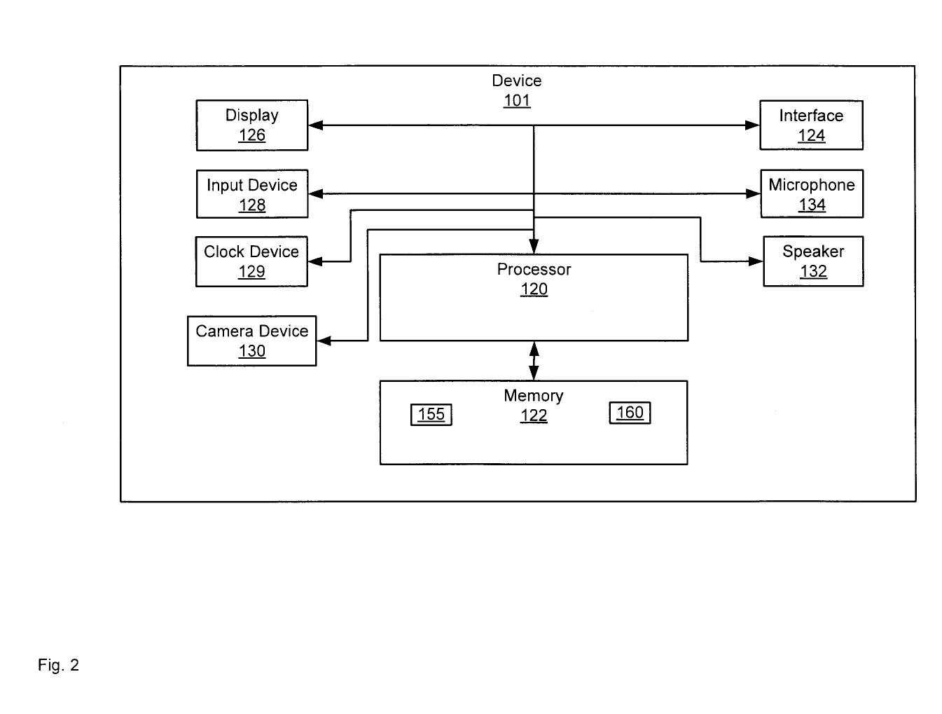

Attention is next directed to FIG. 2, which depicts non-limiting example implementations of device 101. Device 101 comprises: a processor 120, a memory 122, a communication interface 124, a display 126, an input device 128, a clock device 129, and optionally: a camera device 130, a speaker 132, and a microphone 134. Communication interface 124 will be interchangeably referred to hereafter as interface 124; clock device 129 will be interchangeably referred to hereafter as clock 129; camera device 130 will be interchangeably referred to hereafter as camera 130.

Device 101 can include, but is not limited to, any suitable combination of electronic devices, communications devices, computing devices, personal computers, servers, laptop computers, portable electronic devices, mobile computing devices, portable computing devices, tablet computing devices, laptop computing devices, internet-enabled appliances and the like. Other suitable devices are within the scope of present implementations. While, device 101 can be most useful in mobile computing environments, present implementations are not limited to such.

Device 101 can comprise at least one input device 128 generally configured to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations.

Input from interface 124, and/or input device 128, is received at processor 120 (which can be implemented as a plurality of processors, including but not limited to one or more central processors (CPUs)). Processor 120 is configured to communicate with a memory 122 comprising a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of device 101 as described herein are typically maintained, persistently, in memory 122 and used by processor 120 which makes appropriate utilization of volatile storage during the execution of such programming instructions. Those skilled in the art will now recognize that memory 122 is an example of computer readable media that can store programming instructions executable on processor 120. Furthermore, memory 122 is also an example of a memory unit and/or memory module.

Memory 122 further stores an application 155 that, when processed by processor 120, enables processor 120 to: receive, from remote computing device 105 using the communication interface 124, identifier data; generate a machine-readable verification code using a first given algorithm (for example application 155), the first given algorithm configured to encode the identifier data in the verification code; data encoded in the verification code being extractable from the verification code using a second given algorithm complimentary to the first given algorithm; provide the verification code for acquisition by proximal device 103 for transmission to remote computing device 105 to provide a verification of device 101 by extracting at least the identifier data from the verification code using the second given algorithm at remote computing device 105; receive, from the remote computing device using the communication interface, new identifier data to generate a new verification code when the verification code expires after one or more of a given time period and a given number of uses. The verification code can be rendered, for example, at display 126 and/or transmitted to device 103, for example as a near field signal.

Furthermore, memory 122 storing application 155 is an example of a computer program product, comprising a non-transitory computer usable medium having a computer readable program code adapted to be executed to implement a method, for example a method stored in application 155.

In some implementations, as depicted, memory 122 optionally stores a device identifier 160 of device 101, which can include, but is not limited to, one or more identifiers assigned to device 101 by a manufacturer of device 101 and/or at a factory, and the like.

Processor 120 can be further configured to communicate with display 126, clock device 129 and optional microphone 134 and/or speaker 132. Display 126 comprises any suitable one of, or combination of, flat panel displays (e.g. LCD (liquid crystal display), plasma displays, OLED (organic light emitting diode) displays, capacitive or resistive touchscreens, CRTs (cathode ray tubes) and the like). Clock device 129 comprises one or more of a digital clock, a clock at processor 120, and the like, and can provide a time of day and/or a date which can be used by processor 120 to generate the verification code. Optional camera 130 comprises one or more of a digital camera, a CCD (charged coupled device), and the like, and is generally configured to acquire digital pictures, digital images and the like of features within the field of view of camera 130. Optional microphone 134 comprises any suitable microphone for receiving sound and converting to audio data. Optional speaker 132 comprises any suitable speaker for converting audio data to sound to provide one or more of audible alerts, audible communications from remote communication devices, and the like. In some implementations, display 126, input device 128, speaker 132 and/or microphone 134 can be external to device 101, with processor 120 in communication with each of input device 128 and display 126 via a suitable connection and/or link.

Processor 120 also connects to communication interface 124 (interchangeably referred to hereafter as interface 124), which can be implemented as one or more radios and/or connectors and/or network adaptors and/or transceivers, configured to wirelessly communicate with one or more communication networks, including network 117. It will be appreciated that interface 124 is configured to correspond with network architecture that is used to implement communication link 115-1 to network 117, including but not limited to any suitable combination of USB (universal serial bus) cables, serial cables, wireless links, cell-phone links, cellular network links (including but not limited to 2G, 2.5G, 3G, 4G+ such as UMTS (Universal Mobile Telecommunications System), GSM (Global System for Mobile Communications), CDMA (Code division multiple access), FDD (frequency division duplexing), LTE (Long Term Evolution), TDD (time division duplexing), TDD-LTE (TDD-Long Term Evolution), TD-SCDMA (Time Division Synchronous Code Division Multiple Access) and the like), wireless data, Bluetooth links, NFC (near field communication) links, WLAN (wireless local area network) links, WiFi links, WiMax links, packet based links, the Internet, analog networks, the PSTN (public switched telephone network), access points, and the like, and/or a combination.

While not depicted, device 101 further comprises a power source, for example one or more of a battery, a power pack, a connection to a mains power supply, a power adaptor (e.g. an AC-to-DC (alternating current to direct current) adaptor, and the like), and the like.

In any event, it should be understood that a wide variety of configurations for device 101 are contemplated.

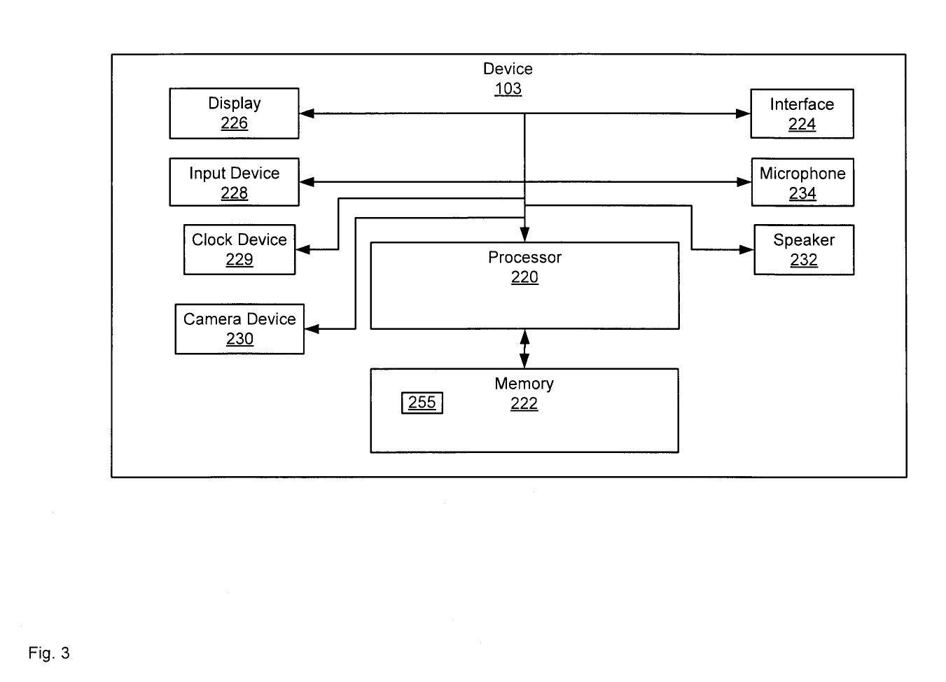

Attention is next directed to FIG. 3, which depicts non-limiting example implementations of device 103. Device 103 comprises: a processor 220, a memory 222, a communication interface 224, a display 226, an input device 228, clock device 229, a camera device 230, and optionally: a speaker 232, and a microphone 234. Communication interface 224 will be interchangeably referred to hereafter as interface 224; clock device 229 will be interchangeably referred to hereafter as clock 229; camera device 230 will be interchangeably referred to hereafter as camera 230.

Device 103 can include, but is not limited to, any suitable combination of electronic devices, communications devices, computing devices, personal computers, servers, laptop computers, portable electronic devices, mobile computing devices, portable computing devices, tablet computing devices, laptop computing devices, internet-enabled appliances and the like. Other suitable devices are within the scope of present implementations. While, device 103 can be most useful in mobile computing environments, present implementations are not limited to such.

Device 103 can comprise at least one input device 228 generally configured to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations.

Input from interface 224, and/or input device 228, is received at processor 220 (which can be implemented as a plurality of processors, including but not limited to one or more central processors (CPUs)). Processor 220 is configured to communicate with a memory 222 comprising a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of device 103 as described herein are typically maintained, persistently, in memory 222 and used by processor 220 which makes appropriate utilization of volatile storage during the execution of such programming instructions. Those skilled in the art will now recognize that memory 222 is an example of computer readable media that can store programming instructions executable on processor 220. Furthermore, memory 222 is also an example of a memory unit and/or memory module.

Memory 222 further stores an application 255 that, when processed by processor 220, enables processor 220 to: acquire, using camera device 230, a machine-readable verification code from display 126 of device 101; transmit, using interface 224, the verification code to remote computing device 105; and receive, using interface 224, a verification of identity of device 101 from remote computing device 105.

In some implementations, processor 220 is further configured to receive password data, and the like, at input device 228, which can include, but is not limited to, a virtual keyboard rendered at a touch screen display (i.e. input device 228 and display 226 can be combined); transmit, using interface 224, the password data to remote computing device 105; and, in response, receive, using interface 224, a further verification of device 101 from remote computing device 105. In other words, in some implementations, device 105 can prompt a user of device 101 to input a password, and the like, to confirm the identity of device 101.

Furthermore, memory 222 storing application 255 is an example of a computer program product, comprising a non-transitory computer usable medium having a computer readable program code adapted to be executed to implement a method, for example a method stored in application 255.

Processor 220 can be further configured to communicate with display 226, camera device 230 and optional microphone 234 and/or speaker 232. Display 226 comprises any suitable one of, or combination of, flat panel displays (e.g. LCD (liquid crystal display), plasma displays, OLED (organic light emitting diode) displays, capacitive or resistive touchscreens, CRTs (cathode ray tubes) and the like). Camera device 230 comprises one or more of a digital camera, a CCD (charged coupled device), and the like, and is generally configured to acquire digital pictures, digital images and the like of features within the field of view of camera device 230; in particular non-limiting implementations, as depicted in FIG. 1, camera device 230 is located to capture images in a field of view adjacent display 226 of device 103 so that a user of device 101 can position display 126 of device 101 facing camera device 230 of device 105 so that camera device 230 can acquire an image thereof.

Optional microphone 234 comprises any suitable microphone for receiving sound and converting to audio data. Optional speaker 232 comprises any suitable speaker for converting audio data to sound to provide one or more of audible alerts, audible communications from remote communication devices, and the like. In some implementations, display 226, camera 230, input device 228, speaker 232 and/or microphone 234 can be external to device 103, with processor 220 in communication with each of input device 228 and display 226 via a suitable connection and/or link.

Processor 220 also connects to communication interface 224 (interchangeably referred to hereafter as interface 224), which can be implemented as one or more radios and/or connectors and/or network adaptors and/or transceivers, configured to wirelessly communicate with one or more communication networks, including network 117. It will be appreciated that interface 224 is configured to correspond with network architecture that is used to implement communication link 115-2 to network 117, including but not limited to any suitable combination of USB (universal serial bus) cables, serial cables, wireless links, cell-phone links, cellular network links (including but not limited to 2G, 2.5G, 3G, 4G+ such as UMTS (Universal Mobile Telecommunications System), GSM (Global System for Mobile Communications), CDMA (Code division multiple access), FDD (frequency division duplexing), LTE (Long Term Evolution), TDD (time division duplexing), TDD-LTE (TDD-Long Term Evolution), TD-SCDMA (Time Division Synchronous Code Division Multiple Access) and the like), wireless data, Bluetooth links, NFC (near field communication) links, WLAN (wireless local area network) links, WiFi links, WiMax links, packet based links, the Internet, analog networks, the PSTN (public switched telephone network), access points, and the like, and/or a combination.

While not depicted, device 103 further comprises a power source, for example one or more of a battery, a power pack, a connection to a mains power supply, a power adaptor (e.g. an AC-to-DC (alternating current to direct current) adaptor, and the like), and the like.

In any event, it should be understood that a wide variety of configurations for device 103 are contemplated.

In particular non-limiting implementations, as depicted in FIG. 1, device 101 comprises a mobile electronic device, such as a cell phone, a smartphone and the like, and device 103 comprises a tablet device, a smartphone and the like.

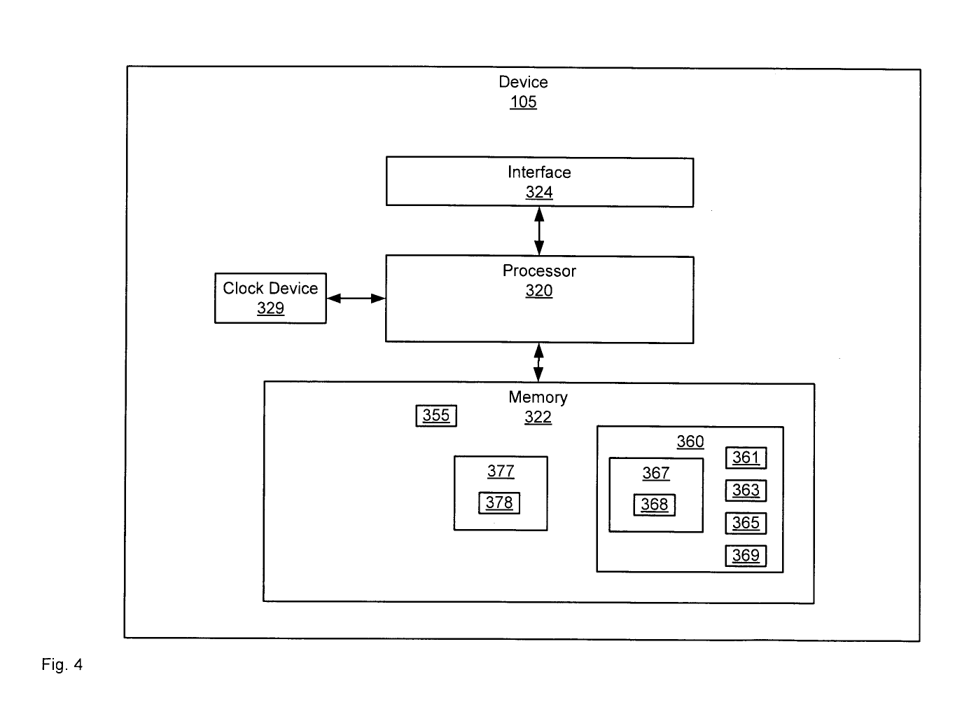

Attention is next directed to FIG. 4, which depicts non-limiting example implementations of device 105. Device 105 comprises: a processor 320, a memory 322, a communication interface 324, and a clock device 329. Communication interface 324 will be interchangeably referred to hereafter as interface 324. Clock device 329 will be interchangeably referred to hereafter as clock 329 and is similar to clock device 129.

Device 105 can include, but is not limited to, any suitable combination of electronic devices, communications devices, computing devices, personal computers, servers, laptop computers, portable electronic devices, and the like. Other suitable devices are within the scope of present implementations.

In particular non-limiting implementations, device 105 comprises a server that can be based on any well-known server environment including a module that houses one or more central processing units, volatile memory (e.g. random access memory), persistent memory (e.g. hard disk devices) and network interfaces to allow device 105 to communicate over a link to communication network 117. For example, device 105 can be a Sun Fire V480 running a UNIX operating system, from Sun Microsystems, Inc. of Palo Alto Calif., and having four central processing units each operating at about nine-hundred megahertz and having about sixteen gigabytes of random access memory. However, it is to be emphasized that this particular server is merely exemplary, and a vast array of other types of computing environments for device 105 are contemplated. For example, Windows™ based servers, Linux based servers and the like are within the scope of present implementations, as well as servers configured for cloud computing. It is further more appreciated that device 105 can comprise any suitable number of servers that can perform different functionality of server implementations described herein.

While not depicted, device 105 can optionally comprise a display, one or more input devices, a speaker, and/or microphone 134.

Processor 320 can be implemented as a plurality of processors, including but not limited to one or more central processors (CPUs)). Processor 320 is configured to communicate with a memory 322 comprising a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of device 105 as described herein are typically maintained, persistently, in memory 322 and used by processor 320 which makes appropriate utilization of volatile storage during the execution of such programming instructions. Those skilled in the art will now recognize that memory 322 is an example of computer readable media that can store programming instructions executable on processor 320. Furthermore, memory 322 is also an example of a memory unit and/or memory module.

Memory 322 further stores an application 355 that, when processed by processor 320, enables processor 320 to: generate, using interface 324, identifier data and transmit the identifier data to device 101; receive, using interface 324, the verification code of device 101 from device 103; process the verification code to extract at least the identifier data there from using a second given algorithm (e.g. application 355) complimentary to first given algorithm at device 101 (e.g. application 155); verify that the identifier data extracted from the verification code matches the identifier data transmitted to device 101; and, in response, transmit a verification of identity of device 101 to device 103. In some implementations, device 105 can comprise two or more servers including, but not limited to, an upper layer server; in these implementations, device 103 communicates with the upper layer server, while identity verification is performed at another server in communication with the upper layer server. Other server architectures are within the scope of present implementations.

In some implementations, processor 320 is further configured to receive transaction data from device 105 and transfer data from an account associated with device 101 to device 103 and/or transfer data from an account associated with device 103 to device 101. For example, when the transaction data comprises payment data (e.g. an amount that a user of device 101 wishes to pay to a user of device 103), data corresponding to a debit from an account associated with device 101 is transferred to an account associated with device 103 as a credit. Alternatively, when the transaction data comprises loyalty program data (e.g. a number of loyalty points amount that a user of device 103 wishes to provide to a user of device 101), data corresponding to a number of loyalty points is transferred to an account associated with device 101 and vice versa. For example device 101 can alternatively use loyalty points to pay an invoice, a bill and the like, with loyalty points being used in place of currency; in such implementations, loyalty points need not be associated with device 103, but can be used to pay an invoice, a bill and the like with any merchant device, similar to device 103, that is registered at device 105. It is appreciated that the accounts associated with each of devices 101, 103 can be stored at memory 322 and/or at one or more other remote computing device; when the accounts associated with each of devices 101, 103 are stored at one or more other remote computing device, device 105 can transmit instructions to the one or more other remote computing devices to effect the transaction. Further, accounts associated with each of devices 101, 103 can be stored at different remote computing devices, and device 105 can transmit instructions to the different remote computing devices to effect the transaction.

Hence, In particular non-limiting implementations, device 105 can be operated and/or associated with an entity which manages accounts, for example accounts associated with devices 101, 103, including, but not limited to a banking entity, an entity managing a loyalty point program, and the like. In other non-limiting implementations, device 105 can be operated and/or associated with an entity that acts as an intermediary between devices 101, 103 and servers, computing devices and the like associated with one or more entities, including, but not limited to a banking entity, an entity managing a loyalty point program, and the like.

In some implementations, processor 320 is further configured to receive password data, and the like, from device 103 using interface 324 and verify the password data by comparing the received password data to password data stored at memory 322; a verification of the password data can be transmitted to device 103. For example, password data associated with device 101 can be received at device 103, transmitted by device 103 to device 105, and device 105 can verify that the password data is associated with device 101.

Furthermore, memory 322 storing application 355 is an example of a computer program product, comprising a non-transitory computer usable medium having a computer readable program code adapted to be executed to implement a method, for example a method stored in application 355.

Memory 322 further stores data 360 associated with device 101, for example password data 361, an identifier data 363 generated by device 105, and an optional device identifier 365. Identifier data 363 can comprise one or more identifiers, including but not, limited to, device identifier 365; in implementations where identifier data 363 comprises device identifier 365, device identifier 365 need not be stored separately from identifier data 363. Data 360 can further include user-account data, for example a username and password for logging into a user-account associated with device 101 and/or for logging into application 155, and device identifier 160. In some implementations, as depicted, account data 367 can include, but is not limited to, a balance 368, such as an amount of currency available to be debited and/or a number of loyalty points available to device 101. Data 360 can be populated in a provisioning session between device 101 and device 105 using links 115-1, 115-3; while not depicted, such a provisioning session can include device 101 downloading application 155 from device 105, and/or alternatively a provisioning server, and uploading password data 361, optional device identifier 365, and/or other data identifying device 101 to device 105. In the provisioning session, device 105 generates data 360 and stores data 360 at memory 322 so that when data associated with device 101 is later received at device 105, such as the verification code, device 105 can verify an identity of device 101.

In some implementations, as depicted, data 360 further comprises restriction data 369 associated with device 101, restriction data 369 comprising one or more of: a number of times that identifier data 363 can be used to verify identity of device 101, a number of times that an identity of device 101 can be verified in one or more time periods (e.g. a number of times per day, a number of times per week, a number of times per month, and the like), a limit on how much can be debited from account 367 without requesting a password, a limit on how much can be debited from account 367 in one or more time periods (e.g. an amount per transaction, an amount per day, an amount per week, an amount per month, and the like; such times can, however, be determined on a sliding basis; furthermore, such amounts and/or times can be set and/or determined by and/or changed by an administrator of system 100 and/or device 105).

Furthermore, while only one set of data 360 is depicted, memory 322 can generally store a plurality of data sets similar to data 360, with one data set stored for each device that is registered with device 105; for example memory 322 can store data sets numbering in hundreds, thousands, millions etc.

In some implementations, as depicted, memory 322 further stores account data 377 associated with device 103, which can be provisioned in a provisioning process (e.g. with device 103 and/or an associated device); account data 377 can include, but is not limited to, a balance 378, such as an amount of currency and/or funds available to device 103 and/or a number of loyalty points available to be provided to device 101 and other devices registered with device 105. Account data 377 can be stored in association with an identifier of device 103.

In yet further implementations, at least a portion of memory 322 can be stored at another device, for example one or more database devices, accessible to device 105.

Processor 320 also connects to communication interface 324 (interchangeably referred to hereafter as interface 324), which can be implemented as one or more radios and/or connectors and/or network adaptors and/or transceivers, configured to wirelessly communicate with one or more communication networks, including network 117. It will be appreciated that interface 324 is configured to correspond with network architecture that is used to implement communication link 115-3 to network 117, including but not limited to any suitable combination of USB (universal serial bus) cables, serial cables, wireless links, cell-phone links, cellular network links (including but not limited to 2G, 2.5G, 3G, 4G+ such as UMTS (Universal Mobile Telecommunications System), GSM (Global System for Mobile Communications), CDMA (Code division multiple access), FDD (frequency division duplexing), LTE (Long Term Evolution), TDD (time division duplexing), TDD-LTE (TDD-Long Term Evolution), TD-SCDMA (Time Division Synchronous Code Division Multiple Access) and the like), wireless data, Bluetooth links, NFC (near field communication) links, WLAN (wireless local area network) links, WiFi links, WiMax links, packet based links, the Internet, analog networks, the PSTN (public switched telephone network), access points, and the like, and/or a combination.

While not depicted, device 105 further comprises a power source, for example a connection to a mains power supply and a power adaptor (e.g. an AC-to-DC (alternating current to direct current) adaptor, and the like).

In any event, it should be understood that a wide variety of configurations for device 105 are contemplated.

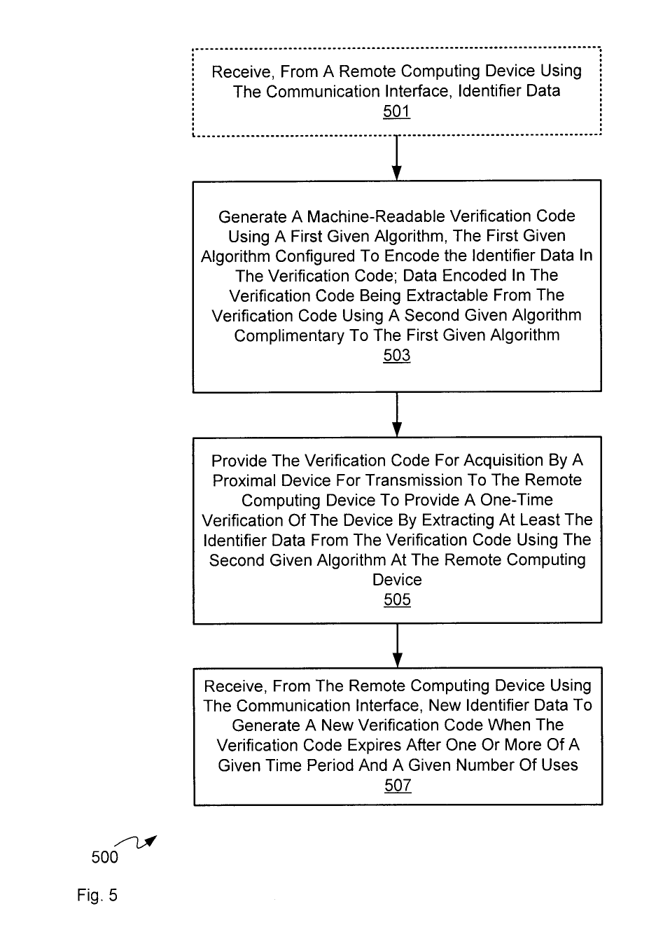

Attention is now directed to FIG. 5 which depicts a flowchart illustrating a method 500 of verifying an identity of a device, according to non-limiting implementations. In order to assist in the explanation of method 500, it will be assumed that method 500 is performed using system 100 and specifically device 101. Furthermore, the following discussion of method 500 will lead to a further understanding of system 100 and device 101 and their various components. However, it is to be understood that system 100 and/or device 101 and/or method 500 can be varied, and need not work exactly as discussed herein in conjunction with each other, and that such variations are within the scope of present implementations. It is appreciated that, in some implementations, method 500 is implemented in device 101 by processor 120, for example by implementing application 155.

It is to be emphasized, however, that method 500 need not be performed in the exact sequence as shown, unless otherwise indicated; and likewise various blocks may be performed in parallel rather than in sequence; hence the elements of method 500 are referred to herein as “blocks” rather than “steps”. It is also to be understood that method 500 can be implemented on variations of device 101 as well.

At block 501, processor 120 receives, from remote computing device 105 using communication interface 124, identifier data. At block 503, processor 120 generates a machine-readable verification code using a first given algorithm, the first given algorithm configured to encode the identifier data in the verification code; data encoded in the verification code being extractable from the verification code using a second given algorithm complimentary to the first given algorithm. At block 505, processor 120 renders the verification code at display 126 for acquisition by proximal device 103 for transmission to remote computing device 105 to provide a verification of device 101 by extracting at least the identifier data 363 from the verification code using the second given algorithm at remote computing device 105. At block 507, device 101 receives, from remote computing device 105 using communication interface 124, new identifier data to generate a new verification code when the verification code expires after one or more of a given time period and a given number of uses.

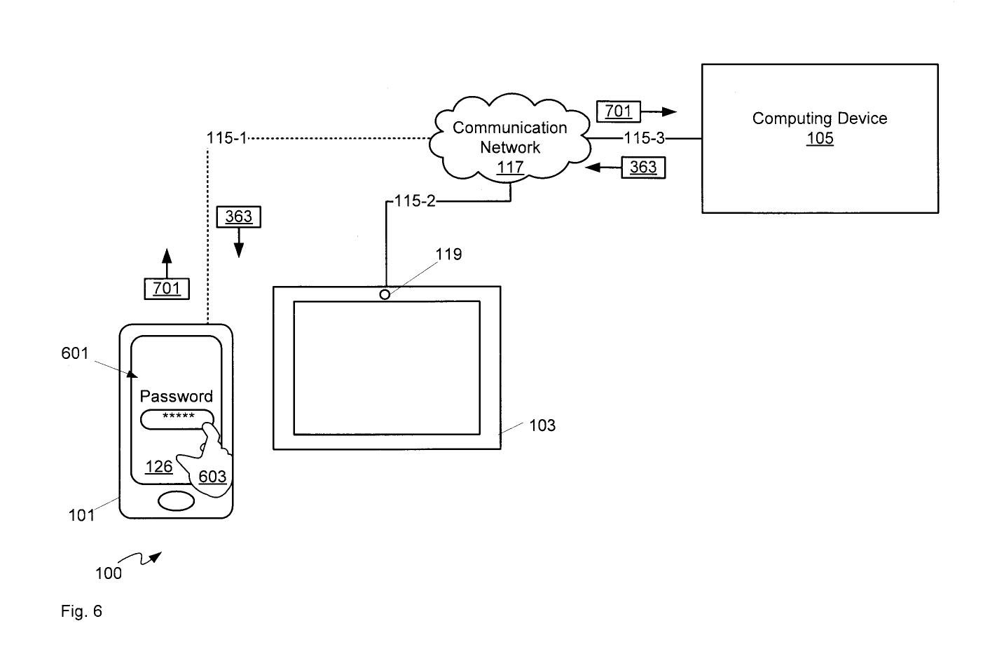

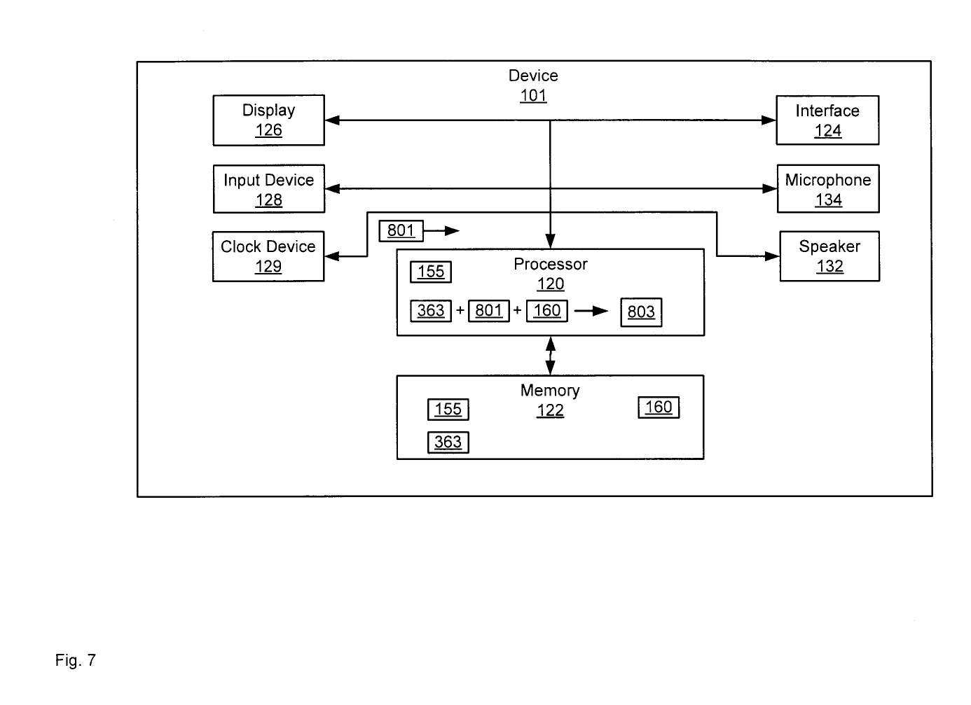

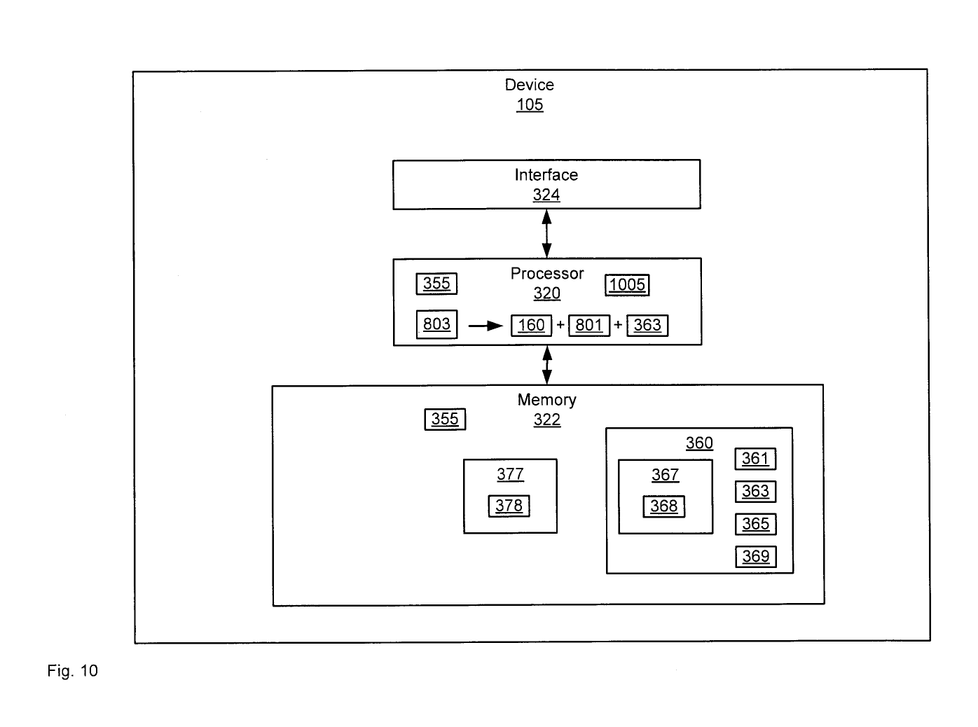

Method 500 will now be described in more detail with reference to FIGS. 6 to 13; FIGS. 6, 8, 9, 11, 12 and 13 are substantially similar to FIG. 1, with like elements having like numbers, while FIGS. 7 and 10 are substantially similar to FIGS. 2 and 4, respectively, with like elements having like numbers.

Attention is next directed to FIG. 6, which depicts device 101 rendering a graphic user interface (GUI) 601 to receive password data, and the like, at application 155, GUI 601 rendered at display 126. For example, password data, which can include, but is not limited to, a password, a PIN, and the like, can be requested by application 155 when given tasks are to be implemented, including, but not limited to: logging into application 155; finalizing transactions using application 155; managing accounts using application 155 (accounts can also be referred to as wallets); accessing a transaction history using application 155; managing and/or accessing a message inbox using application 155; reversing transactions using application 155; changing a password, a PIN and the like of application 155; and, using application 155 for peer-to-peer payments, as described below. In some implementations, when a maximum number of usages of a verification code is reached, and/or a preset time limit is reached device 105 can transmit a request to device 101 to cause device to request password data as in FIG. 6. The password data can be received at a field of GUI 601 when a finger of a hand 603 of the user uses an input device (for example a virtual keyboard (not depicted) rendered at display 126 (e.g. when display 126 comprises a touchscreen) and/or a physical keyboard) to enter the password data in the field. Alternatively (not depicted) an unlock/login screen can comprise fields for receipt of a username and the password (and/or PIN and the like) using an input device at device 101, for example a virtual keyboard (not depicted) rendered at display 126 (e.g. when display 126 comprises a touchscreen).

While not depicted, application 155 can be accessed and/or unlocked (including, but not limited to, after an optional login has occurred) by rendering symbols at a display 126 and an input pattern, and the like, can be received via actuation of the symbols to unlock application 155: for example, application 155 can be configured by a user of device 101 in a provisioning step for unlocking when a finger of a hand 603 of the user is slid through symbols on the unlock screen in a given pattern; in this manner, application 155 can be quickly and conveniently accessed and/or unlocked.

When received password data matches password data stored at memory 122, a request 701 for identifier data 363 can be transmitted to device 105, using interface 124, links 115-1, 115-3 and network 117. Device 105 can return identifier data 363 to device 101 (e.g. block 501 of method 500), where device 101 stores identifier data 363 in memory 122 (as depicted in FIG. 7). Request 701 can be transmitted each time successful unlocking and/or logging of application 155 occurs at device 101

In some implementations, device 105 generates identifier data 363 when request 701 is received: hence, in these implementations, a verification code is generated when password data is received at input device 128 (e.g. a touch screen of device 101). In other implementations, new identifier data 363 can be generated at device 105 periodically and/or after a given number of uses of identifier data 363. Furthermore, identifier data 363 can be generated at device 105 using application 355 and/or using any suitable algorithm for generating identifying codes; for example, identifier data 363 is generally of a size and complexity to distinguish identifier data 363 from other identifier data associated with other devices registered with device 105.

In general, device 101 can request new identifier data 363 each time an application unlocking and/or logging in event occurs (and/or each time a password is received) at device 101 in application 155.

Further, identifier data 363 can comprise data for identifying device 101 that is at least unique at device 105; for example, a plurality of devices can be registered with device 105 and identifier data 363 distinguishes device 101 from other devices registered with device 105. Identifier data 363 can comprise an alpha-numeric identifier (including, but not limited to, ASCII (American Standard Code for Information Interchange) characters, special characters, and the like) generated using an algorithm for generating unique and/or computationally unique identifiers. In some implementations identifier data 363 is randomly generated.

Attention is next directed to FIG. 7, where processor 120 is depicted as processing identifier data 363, an optional time stamp 801 from clock device 129, and optionally device identifier 160 (for example when device identifier 160 is not part of identifier data 363) to generate a machine-readable verification code 803 using a first given algorithm (e.g. block 503 of method 500), for example using application 155. Optional time stamp 801 generally comprises a time that clock device 129 provides to processor 120. In some implementations, generation of verification code 803 can be performed in two steps: a first step for generating an alpha-numeric string and a second step for converting the alphanumeric string to a machine-readable format and/or a graphical representation thereof. For example processor 120 can generate a string from identifier data 363, optional time stamp 801, and optionally device identifier 160; in some of these implementations, the string can be encrypted using an encryption scheme including, but not limited to, a substitution code, a public/private key encryption scheme, scrambling characters of an alphanumeric string using a given pattern, and the like. When a public/private key encryption scheme is used, generation and exchange of private and public keys between device 101 and device 105 can occur at the provisioning and/or registration process described above.

Furthermore, other data can be incorporated into the alphanumeric string: for example, in some implementations, the first given algorithm (e.g. application 155) is further configured to: generate a limited-time identifier of device 101 each time verification code 803 is generated, and encode the limited-time identifier in verification code 803, the second given algorithm at device 105 being further configured to extract the limited-time identifier from verification code 803 and confirm that the limited-time identifier was generated by device 101. Any algorithm for generating such a limited-time code can be used.

In yet further implementations, other data identifying device 101 can also be incorporated into the alphanumeric string and/or the verification code.

In any event, once a string is generated, the first given algorithm converts the alphanumeric string to a machine-readable format so that verification code 803 comprises one or more of: a QR (Quick Response) code, a UPC (Universal Product Code), a graphic, an icon, a symbol, a graphical symbol and the like. In particular non-limiting implementations verification code 803 comprises a QR code.

Furthermore, once identification data 363 is received (e.g. each time password data is received, as in FIG. 6), processor 120 can generate verification code 803 when device 101 is off-line (i.e. not in communication with network 117 and/or when link 115-1 is lost).

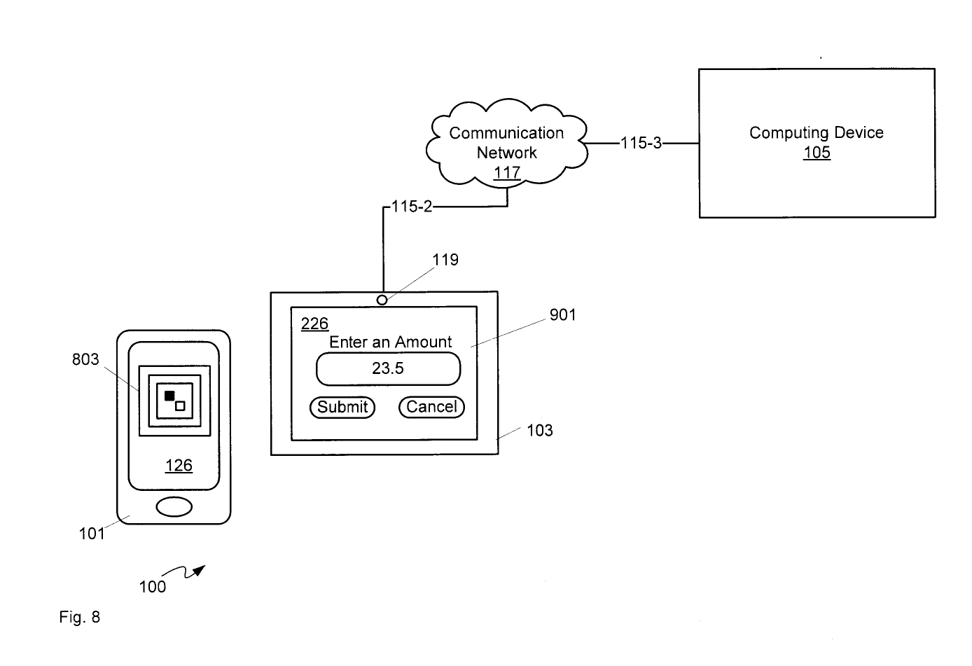

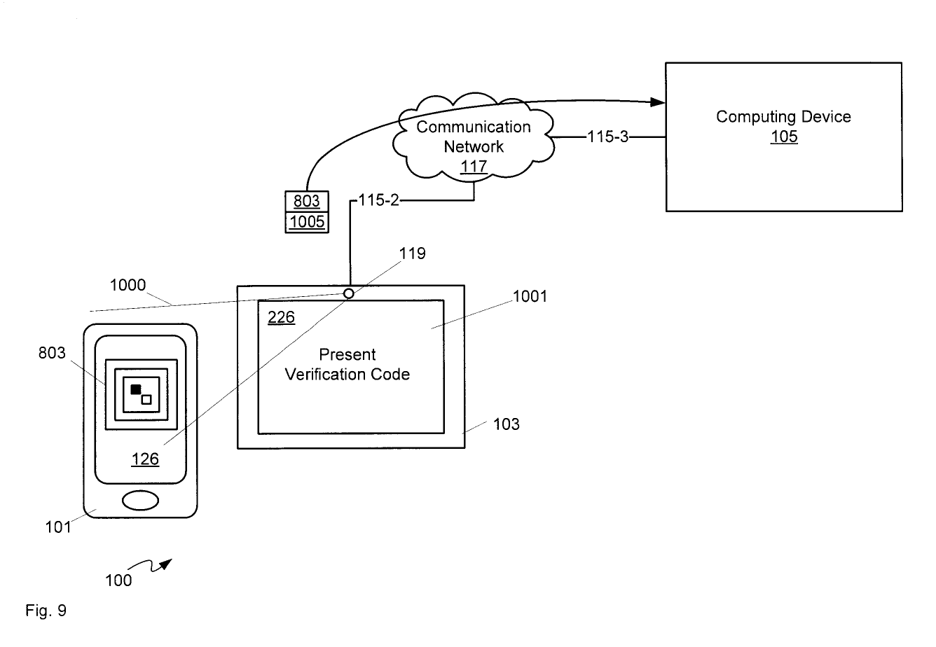

Processor 120 can then render verification code 803 at display 126 (e.g. block 505 of method 500): as depicted in FIG. 8, verification code 803, in particular non-limiting implementations comprises a QR code; it is further appreciated that verification code 803 depicted in FIG. 9 is a stylized schematic QR code with no data encoded therein, and is depicted merely to show an example of a verification code; in a successful prototype, however, verification code 803 comprises a QR code with actual data encoded therein as described above.

Furthermore, FIG. 8 depicts link 115-1 being absent from system 100, indicating that device 101 has gone off-line, though in other implementations, device 101 can be on-line (i.e. link 115-1 is present in system 100) when generating verification code 803.

FIG. 8 further depicts device 103 initiating a transaction by rendering a GUI 901 at display 226 which renders an amount, for example an amount of an invoice, a bill, a cheque and the like. The amount can be received from a point-of-sale (POS) terminal (not depicted) in communication with device 103 using a wired and/or wireless link. Alternatively, the amount can be entered into a field at GUI 901 using a virtual keyboard (not depicted) rendered at display 226 (e.g. when display 226 comprises a touchscreen).

In any event, once the amount is received display 126 of device 101 can be placed into a field-of-view 1000 of external portion 119 of camera device 230 so that camera device 230 can acquire and/or “read” an image of verification code 803, as depicted in FIG. 9. Optional instructions to “Present Verification Code”, and the like, can be rendered in a GUI 1001 at display 226.

Once verification code 803 is acquired at device 103, verification code 803 is transmitted to device 105 using interface 224, links 115-2, 115-3, and network 117, along with transaction data 1005. Transaction data 1005 can include, but is not limited to, the amount received at GUI 901, and an identifier of device 103. Once device 105 receives verification code 803 and transaction data 1005, processor 320 processes verification code 803 to extract identifier data 363, optional time stamp 801 and, optionally, device identifier 160. Device identifier 160 can optionally be extracted from identifier data 363.

Processor 120 can process verification code 803 using a second given algorithm (e.g. application 355) which is complimentary to the first given algorithm at device 101. In other words, the first given algorithm is configured to produce verification code 803 in using a given method and/or process, and the second given algorithm can be used to extract data from verification code 803 using complimentary methods and/or processes that assume that verification code 803 has been produced using the given method and/or process at device 101.

As depicted in FIG. 10, device 105 extracts identifier data 363, optional time stamp 801 and, optionally, device identifier 160. Device 105 can verify identity of device 101 by comparing at least identifier data 363 received in verification code 803 to identifier data 363 stored in memory 322; device 105 can determine that identifier data 363 received in verification code 803 came from device 101 by comparing device identifier 160 with a device identifier stored in data 360.

In some implementations, data encoded in verification code 803 is extractable from verification code 803 at remote computing device 105 using only the second given algorithm (e.g. application 355). In other words, data encoded in verification code 803 is encrypted such that only the second given algorithm can decrypt the data; for example a public/private key system can be used to encrypt the data in verification code 803, though other encryption/decryption schemes are within the scope of present implementations.

Presuming a match between at least identifier data 363 received in verification code 803 to identifier data 363 stored in memory 322, device 105 can determine that an identity of device 101 is valid. Otherwise device 105 determines that the identity of device 101 is invalid.

In some implementations, where time stamp 801 is present in verification code 803, device 105 can further determine whether verification code 803 has been received within a given time period by comparing time stamp 801 with a current time, for example as determined by clock device 329 at device 105: when time stamp 801 and a current time are each within a given time period, for example about one hour (though the given time period can be larger or smaller than about one hour; the given time period can be set by an administrator of device 105, for example), device 105 can determine that the verification code 803 has been received within a valid time period; however, when time stamp 801 and a current time are outside the given time period, device 105 can determine that the verification code 803 has been received within an invalid time period and a verification of identity of device 101 can be denied. In implementations, where optional time stamp 801 is not present in verification code 803, device 105 can store a time that identifier data 363 was generated and/or transmitted to device 101; when a time that verification code 803 is received and/or processed at device 105 is outside of a given time period from the time that identifier data 363 was generated and/or transmitted to device 101, device 105 can determine that the verification code 803 has been received within an invalid time period and a verification of identity of device 101 can be denied.

In yet further implementations, device 105 maintains a count of a number of uses of identifier data 363 and a given time period during which identifier data 363 has been used. When the number of times that identifier data 363 has been used to verify identity of device 101 exceeds a threshold amount and/or when usage of identifier data 363 is outside of a given time period (e.g. about one day, about ten days, and/or any other time period, and the like, since generation of identifier data 363 at device 105), then device 105 can deny verification of identity of device 101.

In implementations where device 105 denies verification of identity of device 101, device 105 can transmit a notification to device 103 indicating that a requested transaction was denied; in some of these implementations, device 105 can further transmit a notification to device 101 indicating that a transaction was denied and that a new identifier data 363 should be requested, for example by re-entering a password, as described above with respect to FIG. 6. The password can be re-entered, as in GUI 601 of FIG. 6, and/or in another GUI that requests a password to trigger requesting new identifier data 363. The notification also serves a warning to device 101 that verification of identity of device 101 in the event that a malicious user has tried to spoof verification code 803.

Device 105 can further perform a check as to whether an amount in balance 368 is greater than or equal to an amount received in transaction data 1005; if not, device 105 can further transmit a notification to device 103 indicating that a transaction was denied. A further notification can be transmitted to device 101 indicating that the transaction was denied; such a notification can further include an indication that the transaction was denied for an inadequate balance rather than a denial of identity verification; in some implementations, a notification to device 101 can further comprise an amount available in balance 368.

However, presuming device 105 verifies identity of device 101, device 105 can transfer an amount corresponding to an amount received in transaction data 1005 from account data 367 to account data 377; in implementations where account data 367, 377 is stored at other devices, device 105 can transmit a request to a device managing account data 367 to debit balance 368 by the amount and transfer the amount to the device managing account data 377. Where account data 367 comprises loyalty plan data, balance 368 can be increased by an amount received in transaction data 1005 that corresponds to a number of loyalty plan points.

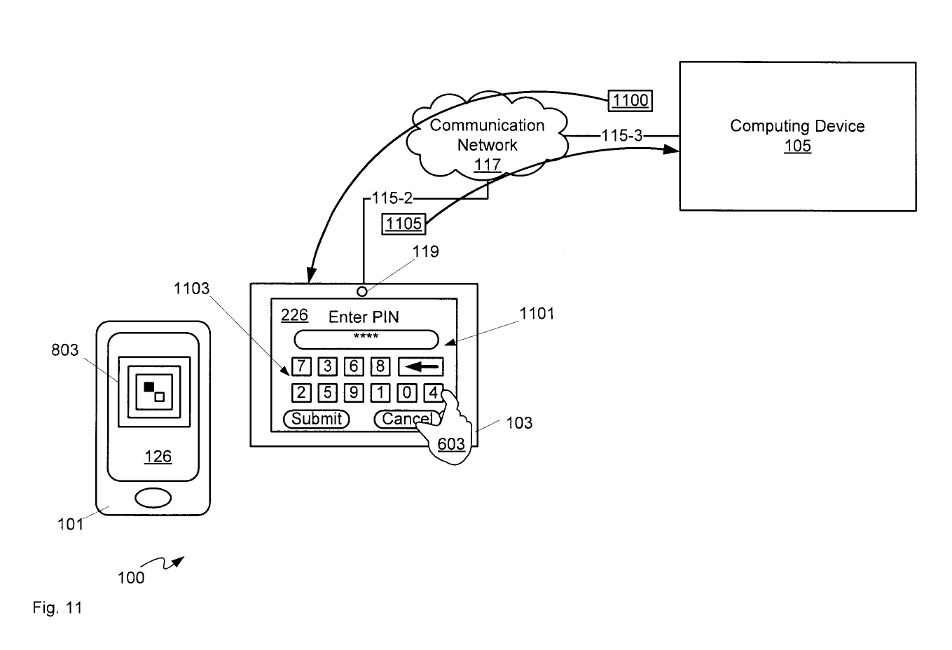

In some implementations, as described above, restriction data 369 places limits on how much can be transferred between accounts without a password; when the amount received in transaction data 1005 is greater than this amount, device 105 transmits a request 1100 for further authorization to device 103 using interface 324, links 115-3, 115-2 and network 117, as depicted in FIG. 11.

In response to receiving request 1100, device 103 renders a GUI 1101 requesting a password, a PIN, and the like from a user of device 101, for example using their hand 603, GUI 1101 including a keypad 1103 for receiving input data corresponding to the password and the like. Once the password, and the like is received, and a “Submit” virtual button, and the like, is actuated by hand 603, password data 1105 is transmitted by device 103 to device 105, and compared to password data 361 stored at memory 322; presuming password data 1105 matched password data 361, device 105 can transfer an amount corresponding to an amount received in transaction data 1005 from account data 367 to account data 377, and the like, as described above.

However, request 1100 can be transmitted and GUI 1101 can be rendered only when a successful verification of device 101 occurs at device 105, and when the amount received in transaction data 1005 is greater than an upper limit placed on a limit placed on a transaction amount in restriction data 369. In other words, a password, a PIN etc. is only requested in GUI 1101, and the like, when a successful verification of identity of device 101 occurs. In some implementations, request 1100 is only transmitted when a transaction amount is valid; that is, all parameters associated with the transaction are validated before request 1100 is transmitted including, but not limited to, an available balance associated with an account, a number of allowed transactions, and the like.

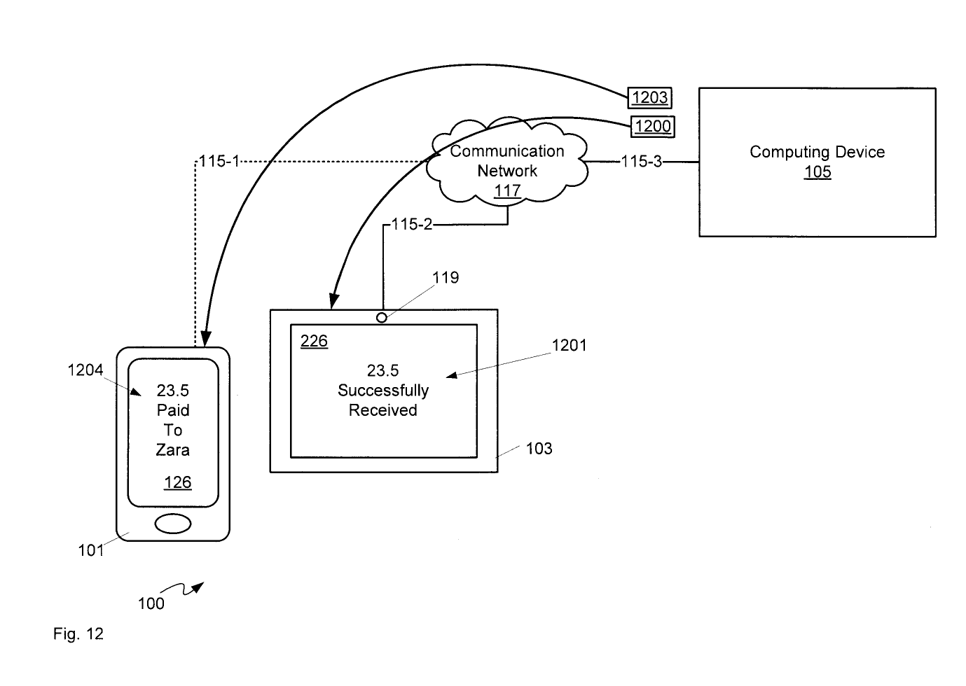

Furthermore, in some implementations, as depicted in FIG. 12, device 105 transmits transaction confirmation data 1200 to device 103, which can then render a GUI 1201 showing a confirmation of the transaction (in some implementations, device 105 can further print a receipt using a printer, including, but not limited to, a Bluetooth™ printer, and the like); device 105 can further transmit transaction confirmation data 1203 to device 101, which can then render a GUI 1204 showing a confirmation of the transaction. In some implementations, each set of transaction confirmation data 1200, 1203 can include an indication of an amount transferred between accounts and/or a number of loyalty points awarded, and the like. In further implementations, one or more of transaction confirmation data 1200, 1203 can include an identifier associated with device 103 (e.g. as depicted, the text “Zara”) and/or an identifier associated with device 101, each identifier stored at device 105 in the provisioning process with each device 101, 103 as described above. For example, each identifier can include text and/or graphics and/or a logo and/or a digital picture associated with each of devices 101, 103.

As described above, in some implementations, verification code is not graphical, but can be provided as, and/or encoded into, one or more of a signal, a radio signal, a near field communication (NFC) signal and the like, in a wireless exchange of data between devices 101 and device 103. In these implementations, each of devices 101, 103 is further configured to transmit and receive such signals.

Furthermore, as described above, device 105 determines whether verification code 803 has expired after one or more of a given time period and a given number of uses. In other words, device 105 can: count a number of uses of verification code 803 and determine whether the number of uses exceeds a threshold amount; and/or determine whether verification code 803 is received outside a given time period; and/or determine whether an optional time stamp in verification code 803 is outside of a given time period. When any of these conditions are determined to occur (i.e. the number uses exceeds a threshold amount, verification code 803 is received outside a given time and/or an optional time stamp in verification code 803 is outside of a given time period), device 105 can transmit new identifier data to device 101. Hence, device 101 receives, from remote computing device 105, using communication interface 124, new identifier data to generate a new verification code when the verification code expires after one or more of a given time period and a given number of uses.

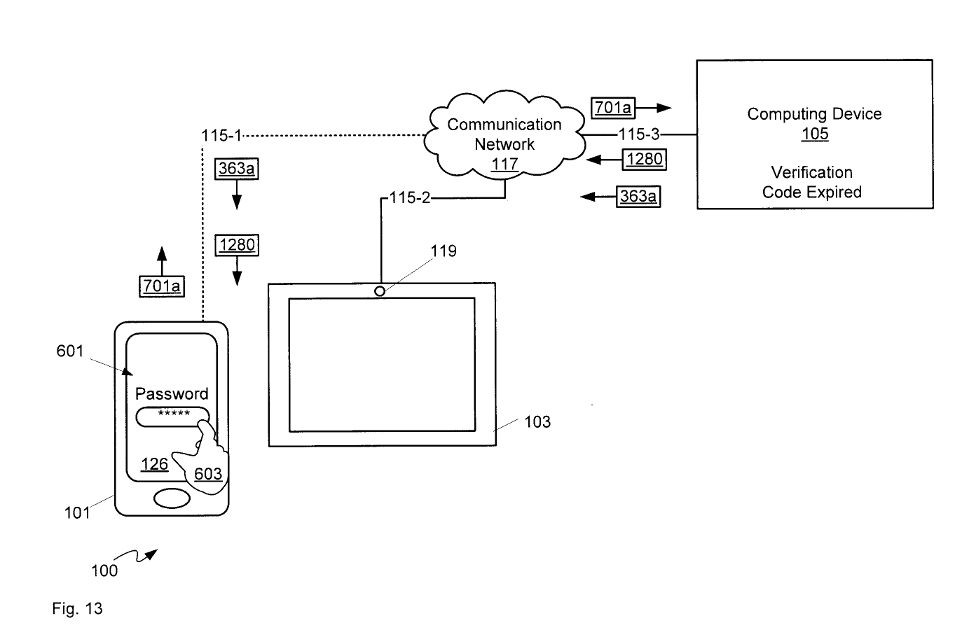

For example, with reference to FIG. 13, device 105 can determine that a verification code 803 has expired and transmit a request 1280 to device 101 to re-enter a password, a PIN and the like, which causes device 101 to request a password, a PIN and the like, using GUI 601 as described above. In response to validating a received password from an input device (e.g. as received at a touchscreen from input received by hand 603 interacting with the touchscreen), device 101 can transmit a request 701a (similar to request 701) for new identifier data to device 105, which generates new identifier data 363a, different from identifier data 363, and transmits new identifier data 363a to device 101. Generation of new identifier data 363a is similar to generation of identifier data 363, though device 105 generates new identifier data 363a in a manner such that new identifier data 363a is different from identifier data 363. For example, device 105 can use a time stamp (which can include, but is not limited to a date) from clock 329 to generate each of identifier data 363 and new identifier data 363a. In addition, each of identifier data 363 and new identifier data 363a is different from identifier data generated for, and transmitted to, other devices in system 100. In any event, device 101 receives new identifier data 363a (e.g. block 507 of method 500) which can be used to generate a new verification code as described above with reference to generating verification code 803; new identifier data 363a will be encoded in the new verification code, and the new verification code will be different from verification code 803.

While present implementations have been described with respect to verifying an identity of device 101 prior to completing electronic transactions, in other implementations verification of the identity of device 101 can occur prior to completing other types of transactions. For example, device 103 can be carried by a courier delivering a package to a user of device 101, and verification code 803 can be presented to device 103, by device 101, prior to delivering the package, presuming that device 105 successfully confirms the identity of device 101 by receiving verification code 803 and transmitting a confirmation to device 103 that verification code 803 was generated by device 101. In these implementations, device 101 registers with device 105 in order to receive identifier data 363 in order to complete a delivery of a package to a user in possession of device 101.

Persons skilled in the art will appreciate that there are yet more alternative implementations and modifications possible. For example, while not depicted, device 103 can provide a log-in screen for logging into application 255 using a user name and a password stored at device 103 and/or computing device 105.

Further, in some implementations, identifier data 363 can expire after one or more of a given number of uses and a given time period. In these implementations, one or more of device 101 and device 105 can count a number of uses of identifier data; once the number of uses reaches a threshold value, which can be as low as one use, either device 101 can request new identifier data 363 from device 105 and/or device 105 can transmit an expiry notification to device 101 and/or device 105 can transmit new identifier data 363 to device 101. When device 105 transmits an expiry notification to device 101, the expiry notification can act as an indicator of a number of times identifier data 363 has been used.

Alternatively, identifier data 363 can expire after a given time period, which can be tracked by one or more of device 101 and device 105. After the given time period, either device 101 can request new identifier data 363 from device 105 and/or device 105 can transmit an expiry notification to device 101 and/or device 105 can transmit new identifier data 363 to device 101.

Hence, processor 120 can be further configured to receive new identifier data 363 after one or more of a given number of uses of the identifier data and a given time period.

In yet further implementations, verification code 803 can be generated in conjunction with one or more of a: further transaction between proximal device 103 and remote computing device 105 (e.g. an exchange of data, account data, loyalty plan data and the like there between), an exchange of payment data between proximal device 103 and remote computing device 105, and an exchange of loyalty plan data between proximal device 103 and remote computing device 105.

As described above with respect to FIG. 11, in some implementations, device 103 can provide a keypad 1103 for receiving a password, a PIN, and the like. In some implementations keypad 1103 can comprise a secure keypad, such that password data 1105 transmitted to device 105 does not comprise the numbers of keypad 1103 in an order corresponding to a password, and the like; rather, in these implementations, device 103 requests data sets from device 105 that correspond to keys of keypad 1103. Hence, once a password, and the like, is received at keypad 1103, corresponding to a selection of a subset of the keys of keypad 1103 in a particular order, a subset of the data sets are transmitted to device 105 in an order corresponding to the selection of associated keys of the subset for verification of the subset.

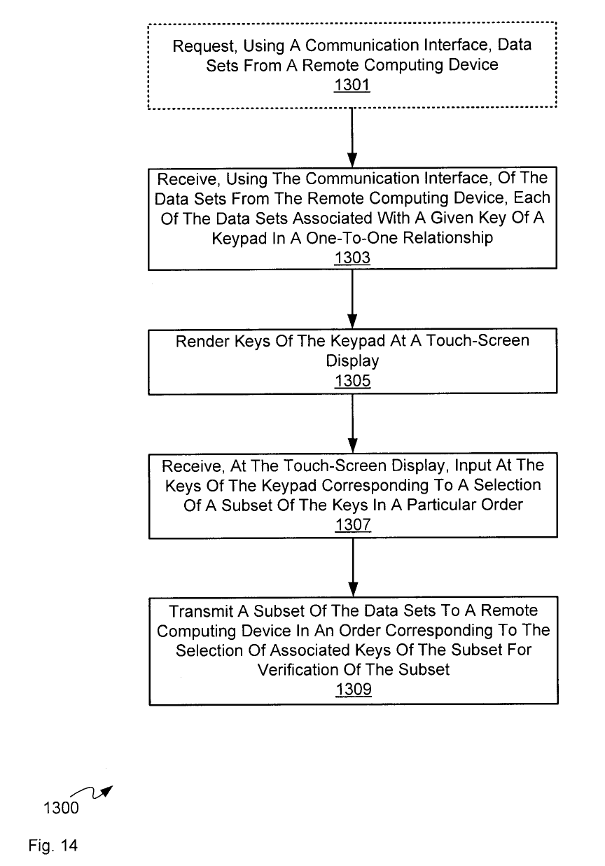

Hence, attention is now directed to FIG. 14 which depicts a flowchart illustrating a method 1300 of providing a secure keypad, according to non-limiting implementations. In order to assist in the explanation of method 1300, it will be assumed that method 1300 is performed using system 100 and specifically device 103. Furthermore, the following discussion of method 1300 will lead to a further understanding of system 100 and device 103 and their various components. However, it is to be understood that system 100 and/or device 103 and/or method 1300 can be varied, and need not work exactly as discussed herein in conjunction with each other, and that such variations are within the scope of present implementations. It is appreciated that, in some implementations, method 1300 is implemented in device 103 by processor 220, for example by implementing application 255 and/or a different application for generating keypad 1103.

It is to be emphasized, however, that method 1300 need not be performed in the exact sequence as shown, unless otherwise indicated; and likewise various blocks may be performed in parallel rather than in sequence; hence the elements of method 1300 are referred to herein as “blocks” rather than “steps”. It is also to be understood that method 1300 can be implemented on variations of device 103 as well.

Furthermore, in method 1300, it is assumed that display 226 of device 103 comprises a touch-screen display; hence, in the description of method 1300 hereafter, display 226 will be interchangeably referred to as touch-screen display 226.

At an optional block 1301, processor 220 requests, using communication interface 224, data sets from remote computing device 105.

At block 1303, processor 220 receives, using communication interface 224, the data sets from remote computing device 105, each of the data sets associated with a given key of keypad 1103 in a one-to-one relationship. When block 1301 is not implemented, block 1303 can occur in conjunction with receiving request 1100 from device 105; in other words, the data sets can be received from device 105 with request 1100.

At block 1305, processor 220 renders keys of keypad 1103 at touch-screen display 226.

At block 1307, processor 220 receives, at touch-screen display 226, input at the keys of the keypad 1103 corresponding to a selection of a subset of the keys in a particular order.

At block 1309, processor 220 transmits a subset of the data sets to remote computing device 105 in an order corresponding to the selection of associated keys of the subset for verification of the subset.

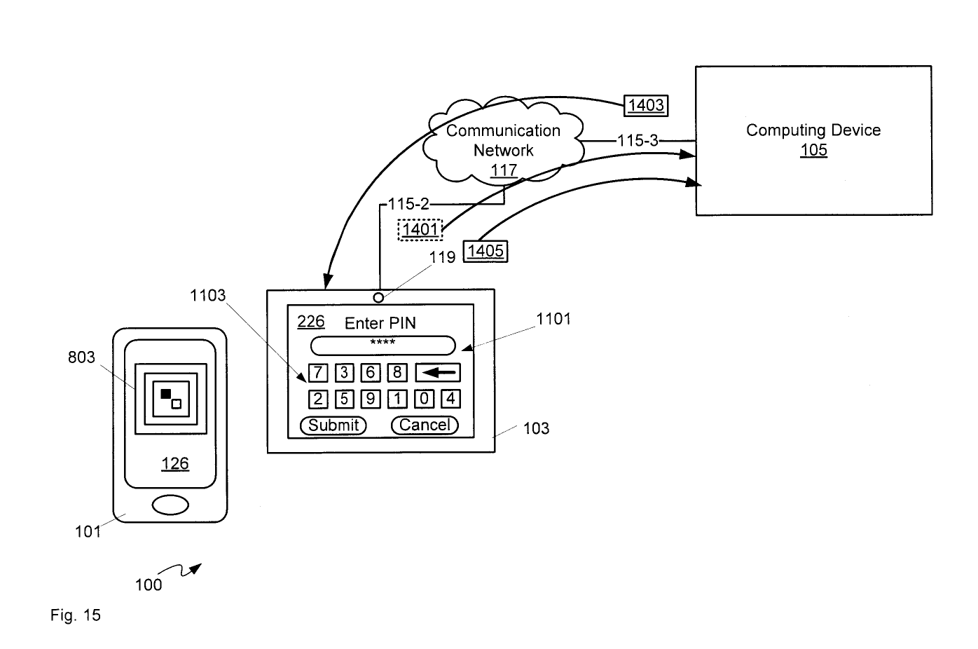

Method 1300 will now be described with respect to FIG. 15, which is substantially similar to FIG. 11, with like elements having like numbers. FIG. 15 depicts device 103 transmitting an optional request 1401 to device 105 (e.g. block 1301 of method 1300); request 1401 can be transmitted in conjunction with and/or prior to rendering keypad 1103. In response, device 105 transmits data sets 1403 to device 103 (e.g. block 1303 of method 1300); however, in some implementations, data sets 1403 can be transmitted in conjunction with request 1100, and request 1401 is optional.

Device 103 receives data sets 1403 and associates the data sets with keys of keypad 1103 (e.g. block 1303 of method 1300). Device 103 renders keypad 1103 at display 226 (e.g. block 1305 of method 1300). In depicted implementations, processor 220 has rendered keys of keypad 1103 in a random order: hence, in such implementations, each time keypad 1103 is rendered, keys of keypad 1103 appear in a different order at display 226. However, it is appreciated that random rendering of keys of keypad 1103 is optional. Furthermore, as described hereafter, an order that keys of keypad 1103 are rendered can depend on data sets 1403.

As depicted, keys of keypad 1103 correspond to numbers in a range of 0 to 9, and are similarly labelled at display 226. However, in other implementations, keys of keypad 1103 correspond to other values and/or text and/or alphanumeric characters and/or graphic characters.

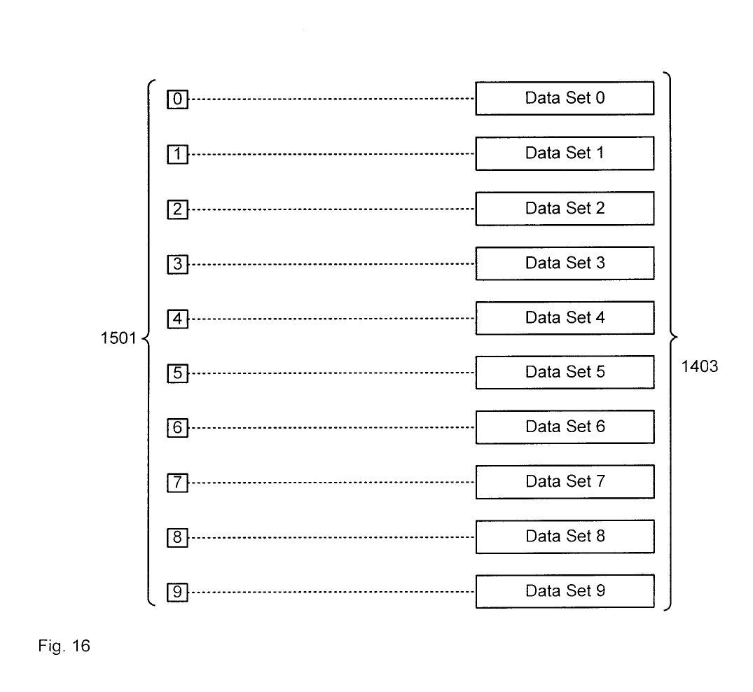

Attention is next directed to FIG. 16 which depicts a relationship between keys 1501 of keypad 1103 and data sets 1403. In particular, each of data sets 1403, labelled data set 0, data set 1, data set 2, is associated with a given key 1501 (e.g. data set 0 is associated with key “0”, data set 1 is associated with key “1”, data set 2 is associated with key “2”, etc.), as represented by the stippled lines there between. In some implementations, data sets 1403 are provided in a matrix by device 105 to device 103, each position in the matrix corresponding to a respective key 1501 of keypad 1103: for example, a first position in the matrix can correspond to key “0”, a second position in the matrix can correspond to key “1”, a third position in the matrix can correspond to key “2”, etc., as depicted in FIG. 16. Hence, when device 103 receives the matrix of data sets 1403, device 103 can associate each of data sets 1403 with keys 1501 based on positions of data sets 1403 in the matrix. Furthermore, the association between keys 1501 and data sets 1403 is stored at device 105, for example in memory 322.

Furthermore each of data sets 1403 can include data representative of a given key 1501, as well as an order in which keys 1501 are to be rendered at device 103. In other words, in these implementations, device 103 does not store specific keys of keypad 1103 and/or an order of the keys; rather rendering of keys of keypad 1103, and their order, occurs according to data sets 1403. For example, keys 1501 can be provided in a random order by device 105 to device 103, so that device 103 renders the keys of keypad 1103 in the same random order.

Each of data sets 1403 can include, but is not limited to, one or more of a digital picture, a randomly generated digital picture, data in a digital picture format, text data, randomly generated text data, and the like. In some implementations where each of data sets 1403 comprises a digital picture, each digital picture can be one or more of about 1 kB, less than about 10 kB, and the like. However one or more of the digital pictures can be larger than about 10 kB. Furthermore, each of the digital pictures can be randomly generated and/or randomly selected. In addition, each of the digital pictures need not comprise a representation of real-world features; rather each of the digital pictures can comprise data arranged in a digital picture format but is otherwise non-representational of real-world pictures.

It is hence further assumed, in method 1300, that device 105 is configured to generate and transmit data sets 1403 to device 103, for example via processor 320 processing application 355 and/or a different application for generating data sets 1403.

Returning to FIG. 15, device 103 receives input at keypad 1103 corresponding to a selection of a subset of keys 1501 in a particular order (e.g. block 1307 of method 1300), the subset representing a password, and the like, as stored in password data 361. Device 103 can then transmit a subset of data sets 1403 as password data 1405 to device 105 in an order corresponding the selection of associated keys so that device 105 can verify the subset (e.g. block 1309 of method 1300). Hence, rather than transmit the received password to device 105, a subset of data sets 1403 is transmitted in password data 1405.

For example, assuming that a password and/or PIN, and the like comprises four characters, “7289”; hence, when keypad 1103 is rendered at display 226, input data is received corresponding to keys “7”, “2”, “8” and “9”, and in the order “7289”. However, rather than transmit “7289” as password data, device 103 transmits, in order, data set 7, data set 2, data set 8, data set 9 as password data 1405. Device 105 receives password data 1405 and, as the association between keys 1501 and data sets 1403 is stored at device 105, device 105 can determine the password, and the like, received as input data at device 103, and compare the password to password data 361 to determine whether a match has occurred, or not.

Additionally, device 103 and/or processor 220 can be further configured to receive new data sets to replace data sets 1403 one or more of: each time keypad 1103 is rendered, and after each time a selection of subset of keys 1501 is received. In other words, data sets 1403 comprise a one-time mapping to keys 1501, which is used only once. For example, assuming a user of device 103 inputs a password incorrectly, for example by mistake, and is prompted to re-enter the password, device 103 receives new data sets to replace data sets 1403, either with a rejection of the incorrect password from device 105 and/or upon a request transmitted from device 103 to device 105.

While implementations of keypad 1103 have been described with reference to ten keys, in other implementations, keypad 1103 can comprise any number of keys, for example keys corresponding to letters of an alphabet and/or keys corresponding to special characters, and/or pictures, and the like, and device 105 is configured to generate a corresponding data set.

Present implementations include alternative techniques are provided for identity verification, including techniques for verifying identity at websites, and the like, as well as techniques for verifying identity for data exchanges between mobile devices.

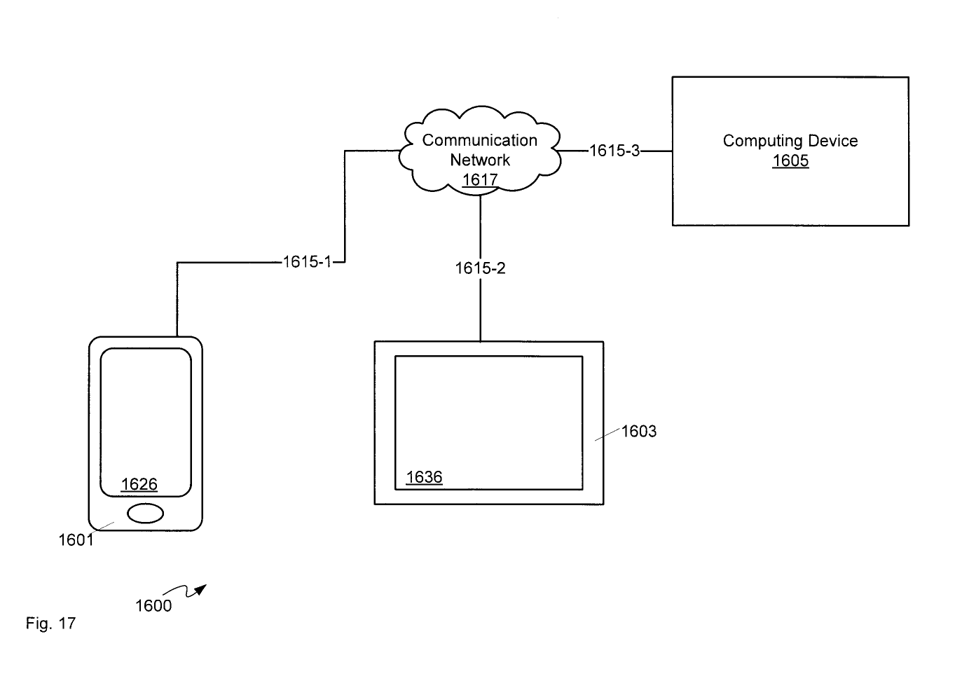

For example, attention is next directed to FIG. 17 which depicts a system 1600 which is substantially similar to system 100, with like elements having like numbers, however preceded by a “16” rather than a “1”. Hence, system 1600 comprises a mobile device 1601, a computing device 1603, and a remote computing device 1605. Each of mobile device 1601, computing device 1603 and remote computing device 1605 will be interchangeably referred to hereafter, respectively, as device 1601, device 1603 and device 1605. While device 1603 is depicted as a tablet device, device 1603 can be any type of computing device that includes a display and an input device. Furthermore, devices 1601, 1603 need not be proximal. In system 1600, each of devices 1601, 1603 1605, are in communication with a communication network 1617 via a respective link 1615-1, 1615-2, 1615-3, interchangeably referred to hereafter, collectively, as links 1615, and generically as a link 1615.

It is furthermore assumed that each of devices 1601, 1603, 1605, comprise at least a respective processor, memory and communication interface, while each of devices 1601, 1605 comprise respective display 1626, 1636.

Device 1603 is generally configured to verify an identity of device 1601 in order to mediate transactions, and the like, between devices, including, but not limited to transactions between device 1603 and device 1605, including, but not limited to electronic payments and the like.

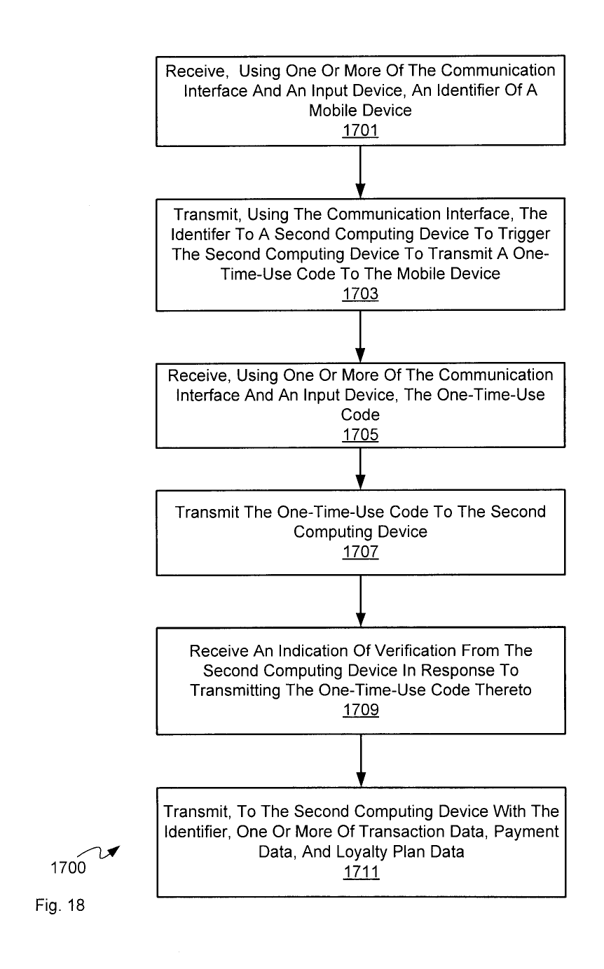

Hence, attention is now directed to FIG. 18 which depicts a flowchart illustrating a method 1700 of verifying a device identity, according to non-limiting implementations. In order to assist in the explanation of method 1700, it will be assumed that method 1700 is performed using system 1600 and specifically device 1603. Furthermore, the following discussion of method 1700 will lead to a further understanding of system 1600 and device 1603 and their various components. However, it is to be understood that system 1600 and/or device 1603 and/or method 1700 can be varied, and need not work exactly as discussed herein in conjunction with each other, and that such variations are within the scope of present implementations. It is appreciated that, in some implementations, method 1700 is implemented in device 1603 by a processor of device 1603.

It is to be emphasized, however, that method 1700 need not be performed in the exact sequence as shown, unless otherwise indicated; and likewise various blocks may be performed in parallel rather than in sequence; hence the elements of method 1700 are referred to herein as “blocks” rather than “steps”. It is also to be understood that method 1700 can be implemented on variations of device 1603 as well.

It is further assumed in method 1700 that device 1603 comprises a processor, a communication interface and a memory: for example, device 1603 can have a structure similar to device 105 as depicted in FIG. 4. It is further assumed that device 1603 is generally configured to implement electronic transactions, as described hereafter.

At block 1701, device 1603 receives, using one or more of a communication interface and input, an identifier of mobile device 1601. For example, device 1603 can comprise a point-of-sale terminal, a merchant terminal, a web server, and the like, and the network address of device 1601 can be received via a message, input data, browser data, and the like.

At block 1703, device 1603 transmits, using the communication interface, the identifier of device 1601 to a second computing device 1605 to trigger second computing device 1605 to transmit a one-time-use code to mobile device 1601.

At block 1705, device 1603 receives the one-time-use code using one or more of the communication interface and the input device.

At block 1707, device 1603 transmits the one-time-use code to second computing device 1605.

At block 1709, device 1603 receives an indication of verification from second computing device 1605 in response to transmitting the one-time-use code thereto.

A block 1711, device 1603 transmits, to second computing device 1605, with the identifier, one or more of transaction data, payment data, and loyalty plan data.

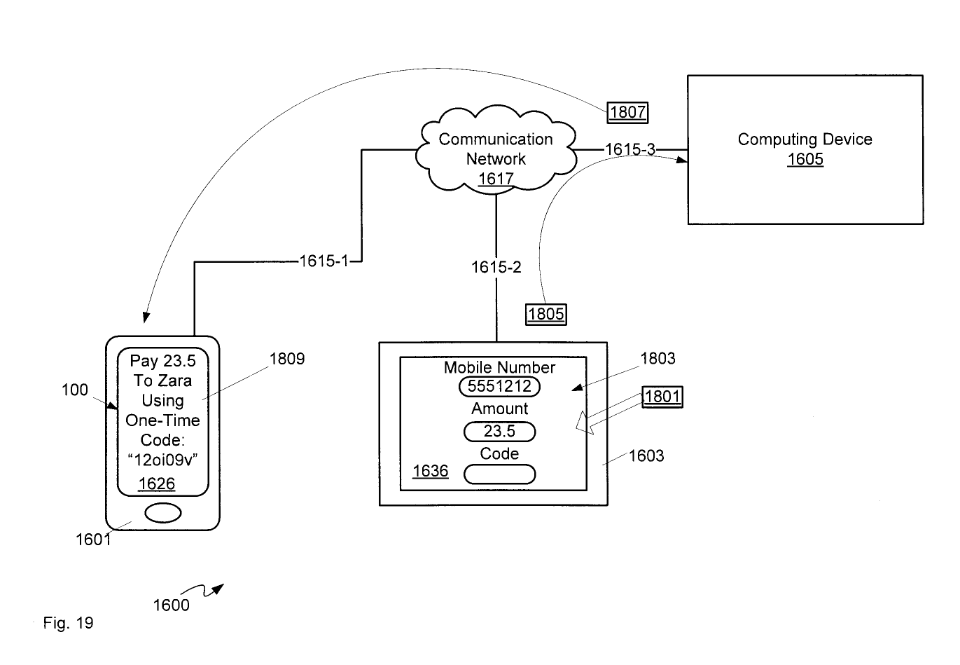

Method 1700 will now be described with reference to FIGS. 18 to 19, each of which is substantially similar to FIG. 17, with like elements having like numbers.

Device 1603 receives data 1801 from one or more of a communication interface and an input device at device 1603, data 1801 including a network address of device 101. In some implementations, as depicted, data 1801 can be rendered at display 1636 in a GUI 1803. GUI 1803 includes a field to receive an identifier of device 1601, including, but not limited to a network address, a telephone number (e.g. “5551212”), an email address, and the like, and a field to enter an amount to be paid to an entity associated with device 1603 (i.e. an amount to be transferred from an account associated with device 1601 to an account associated with device 1603). As depicted, GUI 1803 further includes a field to receive a one-time code to authorize a transaction as described below. In further implementations, a static verification code can be provided to device 1601 in a physical format, for example a QR code provided as a sticker that can be pasted onto device 1601, the static verification code associated with device 1601 at device 1605 in association with a network address of device 1601. However, any static identifier is within the scope of present implementations, including, but not limited to a name, a user ID, and the like.

For example, in some implementations, device 1603 can comprise a point-of-sale terminal, a merchant terminal and the like and data 1801 can be received as input data received at an input device at device 1603 to populate each of the fields. In other words, in these implementations, data 1801 is entered at a device by a merchant and/or at a merchant device, and the like. When the identifier comprises a QR code, and the like, the QR code can be captured by a camera of device 1603 and the field for receiving the identifier is omitted.

Alternatively, device 1603 can comprise a web server and data 1801 can be received as website data from a browser device, including, but not limited to, device 1601 and a computing terminal being used by a user of device 1601. In yet further implementations, device 1603 can comprise a mobile application and interactions with device 1603 can occur using the mobile application.

Hence, block 1701 of method 1700 can be implemented via interactions with device 1603, device 1601 and/or devices associated with devices 1601, 1603, including, but not limited to device 1603 itself.

With further reference to FIG. 19, once at least an identifier of device 1601 is received, and in some implementations an amount, device 1603 can then transmit at least the identifier of device 1601 to device 1605, as data 1805, via links 1615-2, 1615-3 and network 1617. Data 1805 is transmitted prior to receiving a one-time code (i.e. block 1703 is implemented prior to block 1707).

Device 1603 can further transmit one or more of transaction data, payment data, loyalty plan data and the like to device 1605 in data 1805. Indeed, while present implementations are described with reference to an electronic payment, verification of identity for other types of electronic transactions are within the scope of present implementations. Device 1605 can then generate a one-time code 1807 and transmit one-time code 1807 to device 1601 via links 1615-1, 1615-3 and network 1617. One-time code 1807 can be stored at device 1605 in association with an identifier of device 1601, including, but not limited to, the network address.

In particular non-limiting implementations, one-time code 1807 can be transmitted as an SMS (short message service) message. Hence, in implementations where data 1801 is received at device 1603 via an input device, device 1601 need not be a “smart” phone with advanced data capabilities; rather, in these implementations device 1601 can comprise a mobile phone with telephone and texting functions, and no browser functionality and/or advanced data functionality. Such implementations can be particularly useful in cities and countries with limited data communication infrastructure.

Device 1605 is generally configured to generate one-time use code 1807 and transmit one-time code 1807 to device 1601; for example, a user of device 1601 can register a network address, such as a telephone number of device 1601, with device 1605 for identify verification and optionally transactions in order to make on-line payments, and the like; in some implementations, the network address can be registered along with an identifier to be used when identifying device 1601 to device 1603. Hence, device 1605 can be similar to device 105 with account data stored therein, and/or configured to mediate payments between accounts at other devices. It is further appreciated that device 1605 can be similar to device 105, the same as device 105 and/or different from device 105. For example, described herein are implementations where identity verification of smart phones can occur, and implementations where identity verification of non-smart phones can occur; in some implementations, device 1605 can be a specialized device used for identity verification of non-smart phones, while in other implementations device 1605 can be used for identity verification of both smart phones and non-smart phones.

Furthermore, one-time use code 1807 can be similar to identifier data 363 (though identifier data 363 need not be a one-time code) described above, and can be stored at device 1605 in association with an identifier of device 1601, for example the network address. In addition one-time use code 1807 can be transmitted with data indicative of an amount of a transaction and an identifier of device 1603 (e.g. “Zara”).

In response to receiving one-time use code 1807, device 1601 can process an application to provide a GUI 1809 to indicate that a transaction is being requested, GUI 1809 including one-time code 1807 (e.g. “12oi09v”) and optionally an amount to be paid (e.g. “23.5”), and an identifier of device 1603 (e.g. “Zara”).

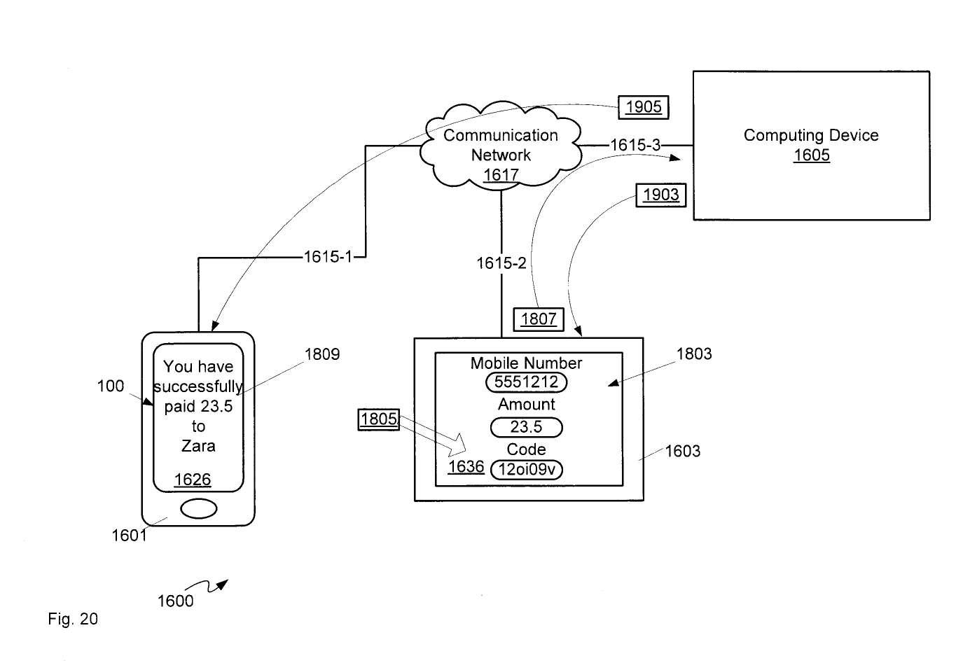

As depicted at FIG. 20, one-time code 1807 is received at device 1603 (e.g. block 1707 of method 1700), for example from an input device at device 1603, a communication interface and the like. In implementations where device 1603 comprises a point-of-sale terminal and the like, one-time code 1807 can be received in a field at GUI 1803 via an input device. While GUI 1803 is depicted as similar in each of FIGS. 18 and 19, in other implementations, GUI 1803 can comprise a first page for receiving the identifier of device 1601 and an amount, and a second page for receiving one-time code 1807. One-time code 1807 can be received via user of device 1601 and/or a user of device 1603 interacting with device 1603; for example, a user of device 1601 can communicate one-time code 1807 to a user of device 1603 (e.g. over the phone) who enters one-time code 1807 into device 1603; alternatively, when devices 1601, 1603 are proximal, the user of device 1601 can be presented with device 1603 and the user of device 1601 can enter one-time code 1807 into device 1603. In yet further implementations, device 1601 can transmit one-time code 1807 to device 1603 via links 1615-1, 1615-2 and network 1617, for example as an SMS message and the like.

In yet further implementations, a password, a PIN and the like associated with device 1601 can be received at device 1603, for example in GUI 1803; the password, PIN and the like can be stored at device 1605 in association with an identifier of device 1601, in a provisioning and/or registration process of device 1601 with device 1605. The password, PIN and the like can be received at device 1603 in a manner similar to receiving one-time code 1807 at device 1603.

Once device 1603 receives one-time code 1807, device 1603 transmits one-time code 1807 to device 1605 so that device 1605 can verify an identity of device 1601. When a password, PIN and the like is received at device 1605 with one-time code 1807, the password, PIN and the like is compared to data stored at device 1605 in association with an identifier of device 1601.

Presuming that device 1605 successfully compares one-time use code 1807 received from device 1603 with the one-time code stored at device 1605 in association with the identifier of device 1601, (and alternatively also successfully compares a password, PIN and the like received from device 1603 with a password, and the like stored at device 1605 in association with the identifier of device 1601) device 1605 transmits an indication 1903 of successful verification of identity of device 1601 to device 1603 (e.g. block 1709 of method 1700). Furthermore, device 1605 can implement the transaction, for example by transferring an amount received at GUI 1803 from an account associated with device 1601 to an account associated with device 1603, presuming an amount is available in the account associated with device 101 that is greater than or equal to an amount to be transferred; if not, a notification of an inadequate amount can be transmitted to device 1601.

Assuming an adequate amount is available, in some of these implementations one of devices 1605, 1603 can further transmit an indication 1905 of successful verification to one or more of devices 1601, 1603, where a respective GUI can provide the amount transferred and an identifier of device 1603 (for example text similar to “You have successfully paid 23.5 to Zara”).

Hence, the indication of verification can include, but is not limited to one or more of transaction data, payment data, loyalty plan data, and the like.

Furthermore, in some implementations, when device 1603 transmits data 1805, device 1603 further transmits an amount of a transaction, and one time code 1807 is valid for this specific transaction only within a certain time frame: for example, a given one-time code will work at a device (e.g. device 1603) associated with a given merchant (or another peer) for a specific amount at a specific time. When the time expires, and/or a given one-time code is used at a device other than one associated with a transaction, the transaction will be denied by device 1605.

Hence, using method 1700 electronic transactions can be implemented using a mobile phone number, and the like. However, in other implementations, electronic transactions can be implemented using a mobile phone number, without the use of a one-time code.

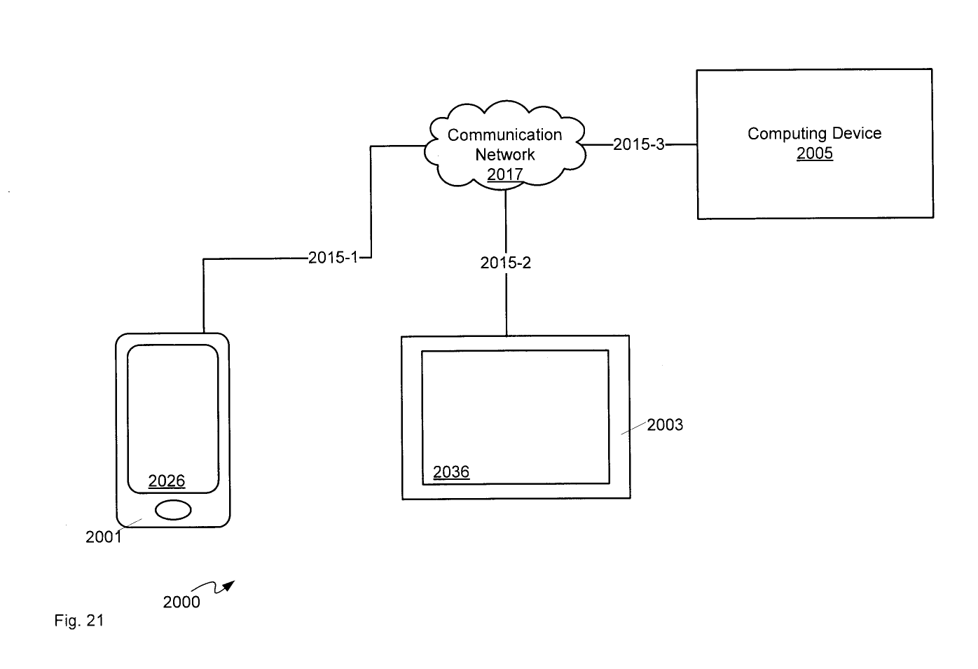

For example, attention is next directed to FIG. 21 which depicts a system 2000 which is substantially similar to system 1600, with like elements having like numbers, however preceded by a “20” rather than a “16”. Hence, system 2000 comprises a mobile device 2001, a computing device 2003, and a remote computing device 2005. Each of mobile device 2001, computing device 2003 and remote computing device 2005 will be interchangeably referred to hereafter, respectively, as device 2001, device 2003 and device 2005. While device 2003 is depicted as a tablet device, device 2003 can be any type of computing device that includes a display and an input device. Furthermore, devices 2001, 2003 are generally not proximal, however device 2001, 2003 can be proximal in some implementations. In system 2000, each of devices 2001, 2003 2005, are in communication with a communication network 2017 via a respective link 2015-1, 2015-2, 2015-3, interchangeably referred to hereafter, collectively, as links 115, and generically as a link 2015. In some implementations, system 2000 can be used for online transactions, as well as mobile transactions.

It is furthermore assumed that each of devices 2001, 2003, 2005, comprise at least a respective processor, memory and communication interface, while each of devices 2001, 2005 comprise respective display 2026, 2036.

Device 2003 is generally configured to verify an identity of device 2001 in order to mediate transactions, and the like, between devices, including, but not limited to transactions between device 2003 and device 2005, including, but not limited to electronic payments and the like.

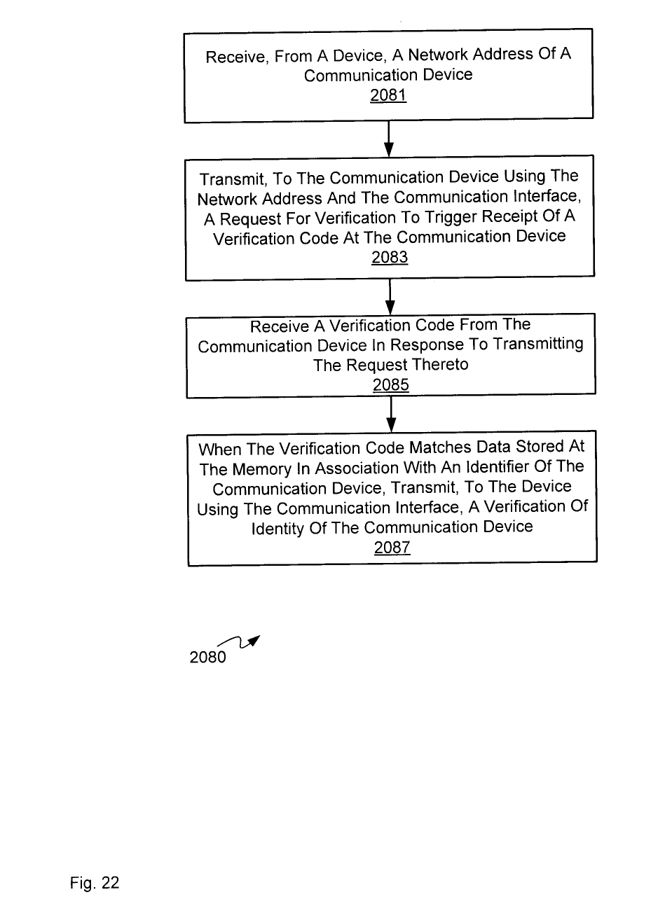

For example, attention is now directed to FIG. 22 which depicts a flowchart illustrating a method 2080 of verifying a device identity, according to non-limiting implementations. In order to assist in the explanation of method 2080, it will be assumed that method 2080 is performed using system 2000 and specifically device 2005. Furthermore, the following discussion of method 2080 will lead to a further understanding of system 2000 and device 2005 and their various components. However, it is to be understood that system 2000 and/or device 2005 and/or method 2080 can be varied, and need not work exactly as discussed herein in conjunction with each other, and that such variations are within the scope of present implementations. It is appreciated that, in some implementations, method 2080 is implemented in device 2005 by a processor of device 2005.

It is to be emphasized, however, that method 2080 need not be performed in the exact sequence as shown, unless otherwise indicated; and likewise various blocks may be performed in parallel rather than in sequence; hence the elements of method 2080 are referred to herein as “blocks” rather than “steps”. It is also to be understood that method 2080 can be implemented on variations of device 2005 as well.

At block 2081, receive, from a device, a network address of a communication device, for example device 2005 receives a network address of mobile device 2001 from device 2003.

At block 2083, device 2005 transmits, to the communication device using the network address and the communication interface of device 2005, a request for verification to trigger receipt of a verification code at the communication device.

At block 2085, device 2005 receives a verification code from the communication device in response to transmitting the request thereto.

At block 2087, when the verification code matches data stored at a memory of device 2005 in association with an identifier of the communication device, device 2005 transmits, to the device using the communication interface, a verification of identity of the communication device.

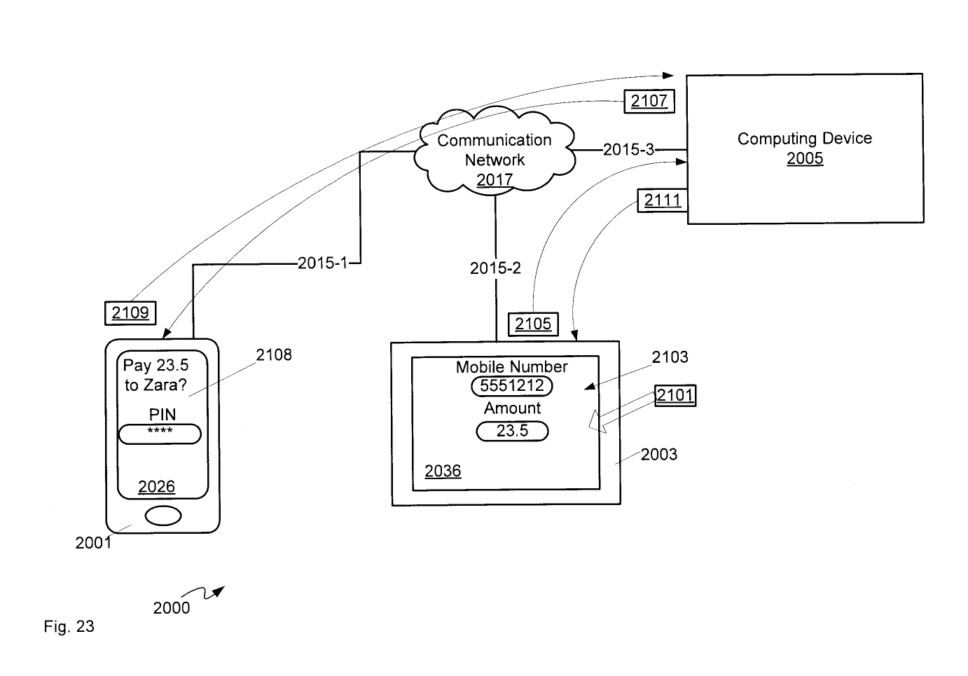

Method 2080 will now be described with respect to FIG. 23, which is substantially similar to FIG. 21, with like elements having like numbers. It is assumed in FIG. 23 that device 2001 has registered with device 2005 and that a password, a PIN and the like is stored in association with an identifier of device 2001 (e.g. a network address) at a memory of device 2005.

Data 2101, including a network address of device 2001, is received at device 2003 in a manner similar to data 1801 being received at device 1603, as described above. For example, a mobile phone number, and the like, of device 2001 can be received via a browser, and/or received in a GUI 2103 rendered at display 2036.

Device 2003 transmits data 2105 for verification to device 2005 using links 2015-2, 2015-3 and network 2017, data 2105 including the network address of device 2001 and being otherwise similar to data 1805. Device 2005 receives data 2105 (e.g. block 2081 of method 2080). Device 2005 transmits to device 2001, using links 2015-1, 2015-3, and network 2017, a request 2107 for verification, request 2107 including an amount received at GUI 2103 (e.g. “23.5”). Device 2001 receives request 2107. In response, device 2001 can render a GUI 2108 at display 2026, GUI 2108 including instructions and fields for requesting a verification code, including but not limited to a password, a PIN and the like, from an input device at device 2001, for example a touch screen display; as depicted, GUI 2108 also include the amount received in GUI 2103. When input data corresponding to the verification code is received at device 2001, device 2001 transmits the verification code 2109 to device 2005 (e.g. block 2085 of method 2080).

When verification code 2109 matches data stored at a memory of device 2005 in association with an identifier of device 2001, device 2005 transmits, to device 2003, a verification 2111 of identity of device 2001 (e.g. block 2087 of method 2080). Alternatively (not depicted) device 2005 can transmit a confirmation to device 2001; a confirmation can be rendered at display 2026, similar to that depicted at device 1601 in FIG. 20. Furthermore, an amount indicated in GUI 2103 can be transferred between accounts associated with devices 2001, 2003 (presuming an adequate amount is available in an account associated with device 2001).

In some implementations, mobile verification of device identity can also be used to implement transaction in a peer-to-peer environment. For example, attention is next directed to FIG. 23, which depicts a system 2200 that is similar to FIG. 1, with like elements having like numbers, but preceded by “22” rather than “1”. System 2200 comprises: a first communication device 2201, a remote computing device 2205, a second communication device 2213, each in communication with a communication network 2217 using a respective link 2215-1, 2215-2, 2215-3 (interchangeably referred to hereafter, collectively, as links 2215, and generically as a link 2215).

First communication device 2201, remote computing device 2205, and second communication device 2213 will be interchangeably referred to hereafter as, respectively, device 2201, device 2205 and device 2213. Furthermore, as depicted, each of devices 2201, 2213 comprise mobile devices, each associated with a network address, including, but not limited to, a mobile phone number. Each of devices 2201, 2205, 2213 each further comprise at least a processor, a memory and a communication interface, similar to other devices described herein. At least device 2201 further comprises a display 2226.

It is further assumed in system 2200 that each of devices 2201, 2213 have registered with device 2205 in a provisioning process, and that device 2205 stores identifiers of each, and can manage accounts associated with each. It is further assumed, in the provisioning process, that at least device 2213 has provided a digital picture to device 2205, for example a digital picture of a user associated with device 2213.

Furthermore, devices 2201, 2213, 2205 need not be co-located nor proximal to one another.

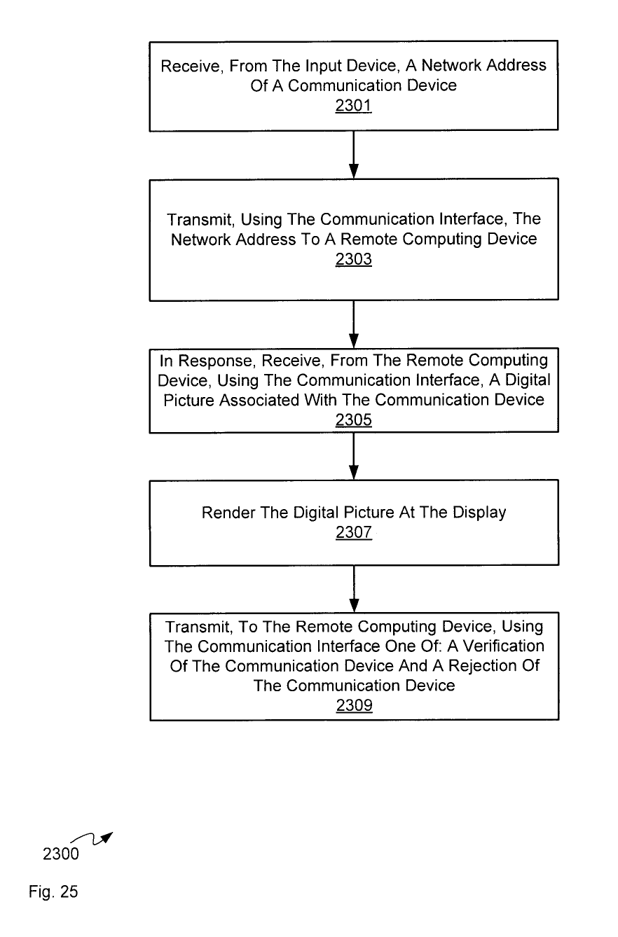

Attention is now directed to FIG. 25 which depicts a flowchart illustrating a method 2300 of verifying a device identity, according to non-limiting implementations. In order to assist in the explanation of method 2300, it will be assumed that method 2300 is performed using system 2200 and specifically device 2201. Furthermore, the following discussion of method 2300 will lead to a further understanding of system 2200 and device 2201 and their various components. However, it is to be understood that system 2200 and/or device 2201 and/or method 2300 can be varied, and need not work exactly as discussed herein in conjunction with each other, and that such variations are within the scope of present implementations. It is appreciated that, in some implementations, method 2300 is implemented in device 2201 by a processor of device 2201.

It is to be emphasized, however, that method 2300 need not be performed in the exact sequence as shown, unless otherwise indicated; and likewise various blocks may be performed in parallel rather than in sequence; hence the elements of method 2300 are referred to herein as “blocks” rather than “steps”. It is also to be understood that method 2300 can be implemented on variations of device 2201 as well.

At block 2301, device 2201 receives, from an input device thereof, a network address of communication device 2213. In some implementations, an amount (e.g. an amount to be transferred) can be received concurrent with the network address.

At block 2303, device 2201 transmits, using a communication interface thereof, the network address to remote computing device 2205.

At block 2305, in response to block 2303, device 2213 receives, from remote computing device 2205, using the communication interface, a digital picture associated with communication device 2213.

At block 2307, device 2201 renders the digital picture at display 2226.

At block 2309, in response to rendering the digital picture, device 2201 transmits, to remote computing device 2205, using the communication interface one of: a verification of communication device 2213 and a rejection of communication device 2213. It is appreciated that a verification of communication device 2213 can include an indication of an approval of a transaction.

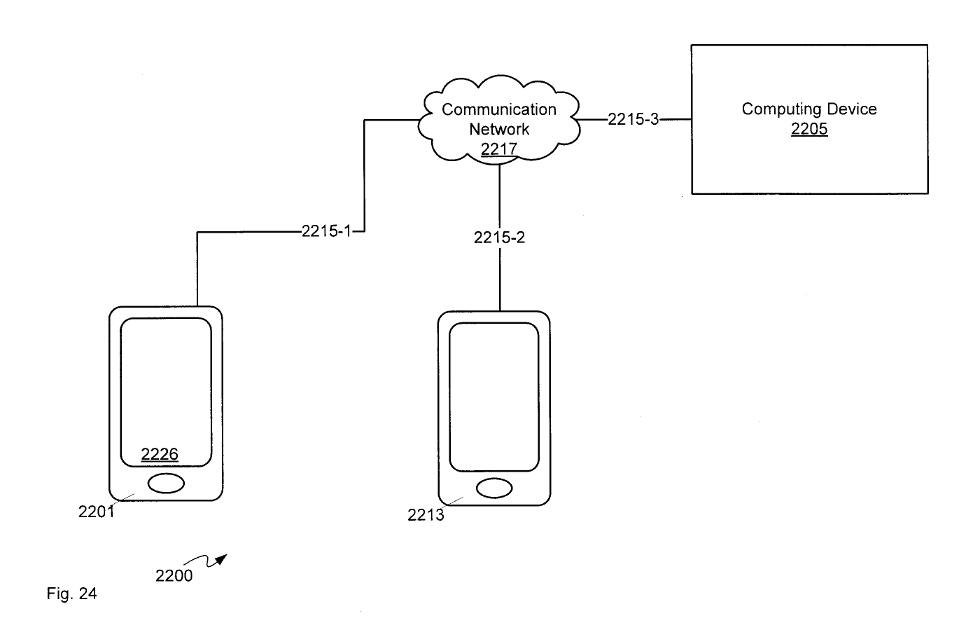

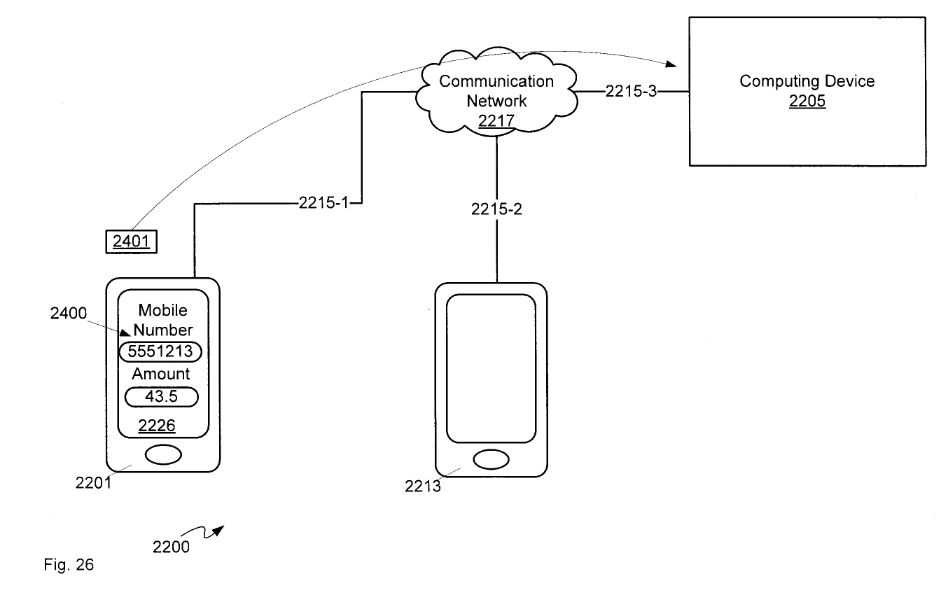

Method 2300 will now be described with reference to FIGS. 25 and 26, each of which is substantially similar to FIG. 24, with like elements having like numbers. It is furthermore assumed in FIGS. 25 and 26 that a processor of device 2201 is processing an application for verifying an identity of device 2213 so that a transaction can occur between an account associated with device 2201 and an account associated with device 2213. In FIG. 26, device 2201 renders a GUI 2400 at display 2226 to request network address, including but not limited to a mobile number of device 2213, and amount to be transferred to an account associated with device 2213. The network address, and the amount, can be received from an input device of device 2201, for example a touch screen display (e.g. block 2301 of method 2300). Device 2201 then transmits at least the network address to device 2205 as data 2401 (e.g. block 2303 of method 2300), which can also include the amount. Data 2401 can be transmitted upon actuation of a virtual button and the like (not depicted).

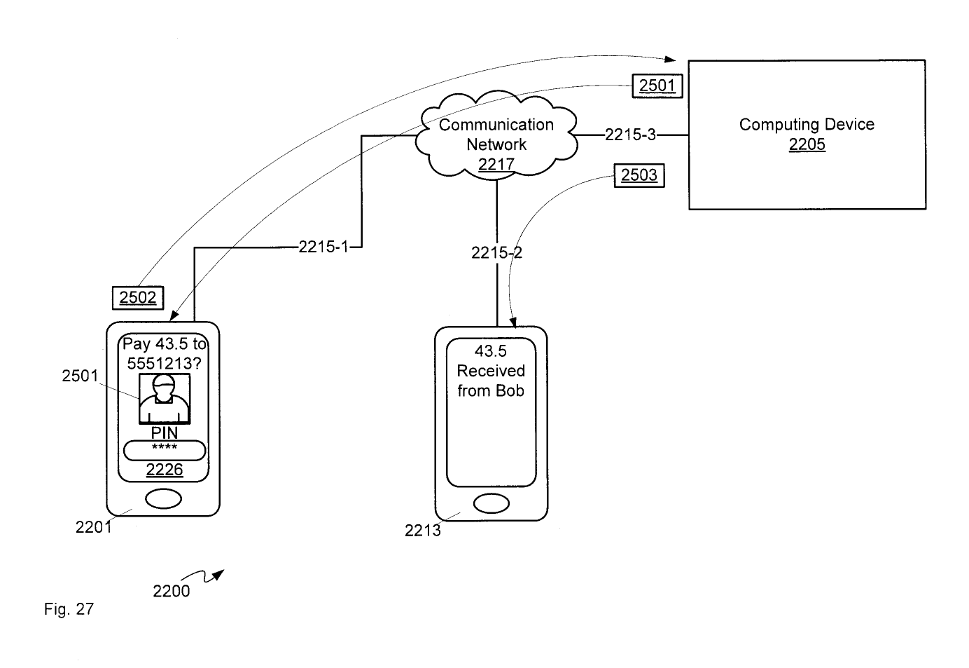

Data 2401 is received at device 2205, and device 2205 processes the network address to retrieve a digital picture associated with the network address. With reference to FIG. 27, digital picture 2501 is transmitted to device 2201 (e.g. block 2305 of method 2300), where device 2201 renders digital picture 2501 in a GUI. A user of device 2201 can confirm that digital picture 2501 is one or more of representative of a user of device 2213 and/or associated with device 2213 by entering a password, and the like at device 2201 to confirm verification of device 2213. However, when digital picture 2501 is not representative of user of device 2213, and the like, the user of device 2201 can reject verification of device 2213, for example in situations where the network address was entered incorrectly and the user is attempting a transaction with an incorrect device. Rejection can occur using a virtual button (not depicted) to cancel a transaction. Hence, device 2201 can transmit data 2502 representative of one of a verification of the communication device 2213 and a rejection of the communication device 2213 to device 2205. Presuming verification of device 2213 is successful, device 2205 can receive data 2502, process the associated transaction between associated accounts of devices 2201, 2213, and optionally transmit an indication 2503 of the transaction to device 2213, for example as an application notification, and/or an SMS (short message service) message and/or an email, which can render indication 2503 at a display thereof (as depicted).

In some implementations, device 2213 can reverse the transaction by transmitting a notification to device 2205 to do so within a given time period (including, but not limited to one hour, a few hours, and the like).

Furthermore, in some implementations, digital picture 2501 is only transmitted when a transaction amount is valid: that is, all parameters associated with the transaction are validated before digital picture 2501 is transmitted including, but not limited to, an available balance associated with an account, a number of allowed transactions, and the like.

Method 2300 assumes, however, that each of devices 2201, 2213 is registered with device 2205. However, present implementations further provide for verifying identity of devices that are not registered in a peer-to-peer environment.

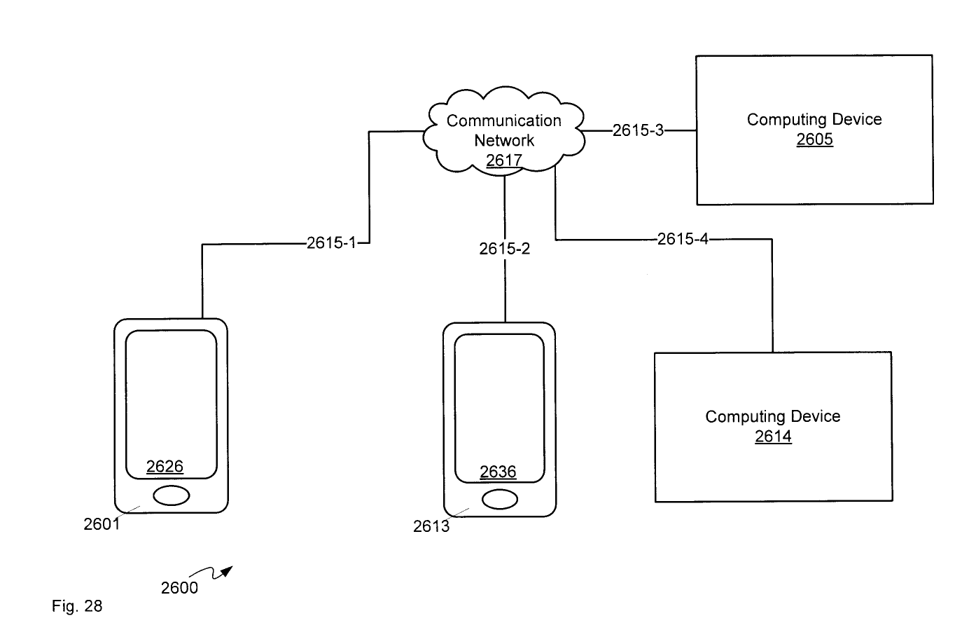

For example, attention is next directed to FIG. 27 substantially similar to FIG. 24, with like elements having like numbers, however preceded by “26” rather than “22”. Specifically, FIG. 28 depicts a system 2600 comprising: a first communication device 2601, a first computing device 2605, a second communication device 2613, and a second computing device 2614, each in communication with a communication network 2617 using a respective link 2615-1, 2615-2, 2615-3, 2615-4 (interchangeably referred to hereafter, collectively, as links 2615, and generically as a link 2615). First communication device 2601, first computing device 2605, second communication device 2613, and second computing device 2614 will be interchangeably referred to hereafter as, respectively, device 2601, device 2605, device 2613 and device 2614. Furthermore, as depicted, each of devices 2601, 2613 comprise mobile devices, each associated with a network address, including, but not limited to, a mobile phone number. Each of devices 2601, 2605, 2613, 2614 further comprise at least a processor, a memory and a communication interface, similar to other devices described herein. At least devices 2601, 2613 further comprise respective displays 2626, 2636. In some implementations, device 2614 can also comprise a display (not depicted). It is further assumed in system 2600 that device 2601 has registered with device 2605 in a provisioning process and that device 2605 stores an identifier of device 2601, and can manage an account associated therewith. However, it is further assumed that device 2613 has not registered with device 2605.

Furthermore, devices 2601, 2613, 2605, 2614 need not be co-located nor proximal to one another.

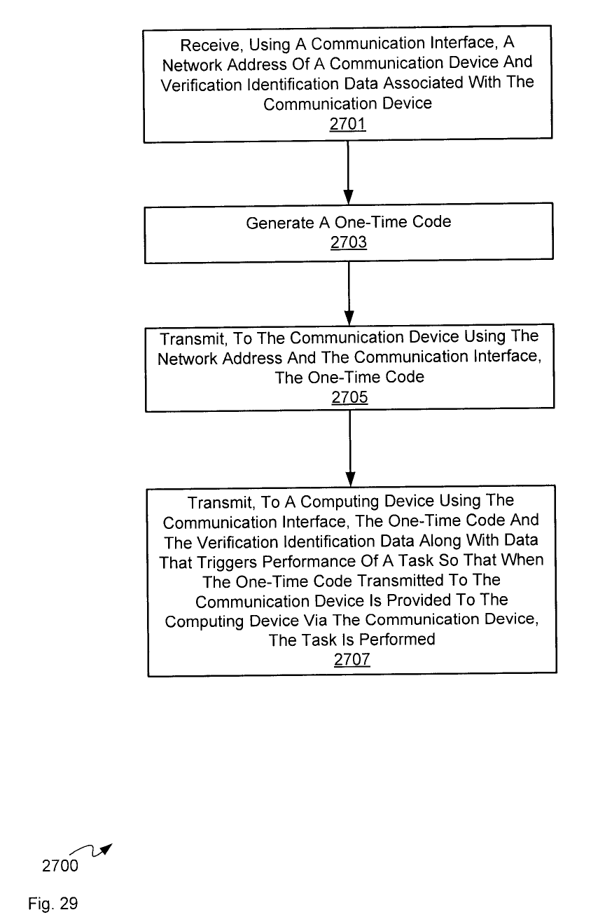

Attention is now directed to FIG. 29 which depicts a flowchart illustrating a method 2700 of verifying a device identity, according to non-limiting implementations. In order to assist in the explanation of method 2700, it will be assumed that method 2700 is performed using system 2600 and specifically device 2605. Furthermore, the following discussion of method 2700 will lead to a further understanding of system 2600 and device 2605 and their various components. However, it is to be understood that system 2600 and/or device 2605 and/or method 2700 can be varied, and need not work exactly as discussed herein in conjunction with each other, and that such variations are within the scope of present implementations. It is appreciated that, in some implementations, method 2700 is implemented in device 2605 by a processor of device 2605.

It is to be emphasized, however, that method 2700 need not be performed in the exact sequence as shown, unless otherwise indicated; and likewise various blocks may be performed in parallel rather than in sequence; hence the elements of method 2700 are referred to herein as “blocks” rather than “steps”. It is also to be understood that method 2700 can be implemented on variations of device 2605 as well.

At block 2701, device 2605 receives, using a communication interface, a network address of a communication device, for example device 2613, and verification identification data associated with the communication device. The network address and verification identification data can be received from device 2601

At block 2703, device 2605 generates a one-time code.

At block 2705, device 2605 transmits, to the communication device using the network address and the communication interface, the one-time code;

At block 2707, device 2605 transmits, to a computing device (for example device 2614) using the communication interface, the one-time code and the verification identification data along with data that triggers performance of a task so that when the one-time code transmitted to the communication device is provided to the computing device via the communication device, the task is performed.

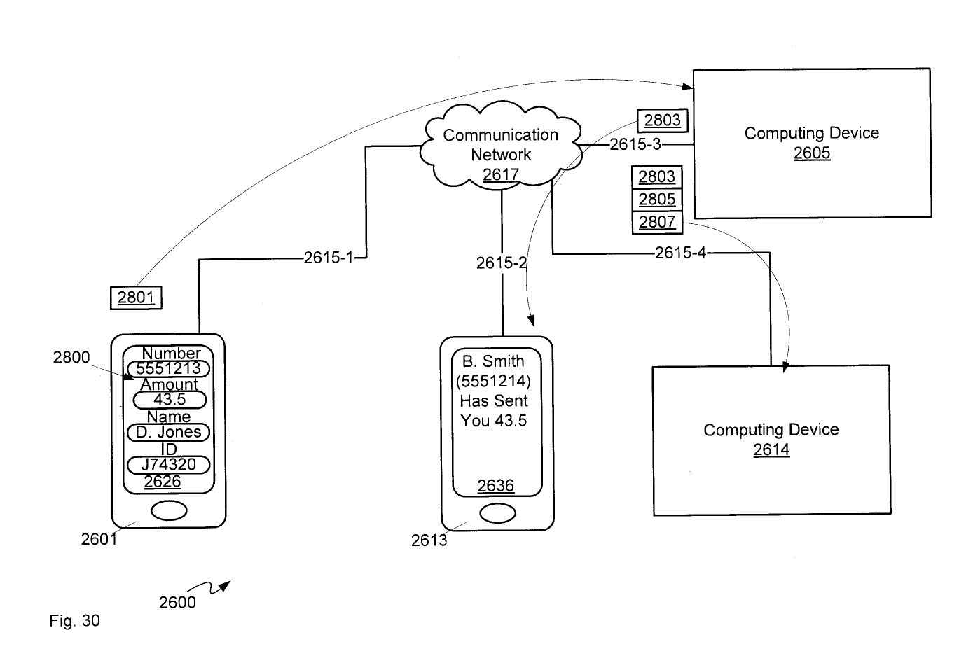

Method 2700 will now be described with reference to FIG. 30 which is substantially similar to FIG. 24 with like elements having like numbers. It is furthermore assumed in FIG. 30 that a processor of device 2605 is processing an application for verifying an identity of device 2613 so that a transaction can occur between an account associated with device 2601 and device 2613. It is yet further assumed in FIG. 30 that a processor of device 2601 is processing an application for verifying an identity of device 2613 so that a transaction can occur between an account associated with device 2601 and device 2613. In FIG. 30, device 2601 renders a GUI 2800 at display 2626 to request a network address of device 2613, including but not limited to a mobile number of device 2613 (e.g. “5551213”), an amount to be transferred from an account associated with device 2601, and identification verification data associated with device 2613, including, but not limited to, a name of a user associated with device 2613 (e.g. “D. Jones”) and optionally an identification (“ID”) number associated with device 2613 (including, but not limited to, number of government-issued identification, a driver's license number, a social security number, and the like). The data received at GUI 2800 can be received from an input device of device 2613, for example a touch screen display. Device 2601 then transmits at least the network address and the verification identification data to device 2605 as data 2801 (e.g. block 2303 of method 2300), which can also include the amount. Data 2801 can be transmitted upon actuation of a virtual button and the like (not depicted) at device 2601.

Device 2605 receives data 2801 (e.g. block 2701 of method 2700). Device 2605 can compare the amount received with an amount in an account associated with device 2601 to ensure there are enough funds, and the like, available in the account: if not, a notification can be transmitted to device 2601 indicative of such. Otherwise, the amount is withdrawn from the account and alternatively stored in a temporary account. Also presuming enough funds, device 2605 generates a one-time code 2803 (e.g. block 2703 of method 2700) and transmits one-time code 2803 to device 2613 (e.g. block 2705 of method 2700), for example in a message, an SMS, an email and the like, using the network address received in data 2801. One-time code 2803 can include, but is not limited to text comprising one or more identifiers associated with device 2601 (for example a mobile number, “5551214” as depicted), the amount, and the like; in some implementations, one-time code 2803 can include a uniquely assigned alpha-numeric identifier, and the like. In any event, device 2613 can render the one-time code 2803 at display 2636, as depicted. In some implementations, device 2605 can further transmit to device 2613 an invitation to register with device 2605 so that automatic transaction can occur between accounts associated with devices 2601, 2613, as with method 2300.

Device 2605 furthermore transmits one-time code 2803, verification identification data 2805 and data 2807 that triggers performance of a task to device 2614 (e.g. block 2707 of method 2700). Data 2807 can include instructions to pay the amount received at GUI 2800 to a user associated with device 2613 upon presentation of the one-time code and identification that matches verification identification data 2805. Hence, for example, device 2614 can comprise a computing device operated by a banking entity, a financial services entity and the like, and the user associated with device 2613 can provide one-time code 2803 received at device 2613 to a teller, and the like, at a physical location operated by the banking entity and the like, along with identification. Presuming the presented one-time code matches one-time code 2803 received at device 2614, and the identification presented to the teller by the user matches verification identification data 2805 received at device 2614, the teller can provide the user with funds corresponding to the amount.

In some implementations, the transaction can be associated with a given time period, so that, when the transaction does not occur within the given time period (including, but not limited to a week, a month, and the like, though any time period is within the scope of present implementations), the transaction is automatically reversed by device 1605 and devices 2601, 2613 are each notified of the reversal.

Alternatively, method 2700 can be used in a courier environment to request a user of device 2613 to come to physical location of the courier and retrieve a package upon presentation of one-time code 2803 and identification. For example, a user of device 2601 can ship a package to a user of device 2613 and use a GUI similar to GUI 2800 (but without the amount) to provide information for verifying identity of device 2613 so that the user of device 2613 can retrieve the package.

Provided herein are devices, methods and systems of mobile identity verification, including identity verification of mobile devices. In each case, identity of a mobile device can be provided prior to initiating a transaction, such as transfer between accounts, issuance of loyalty plan points, delivering of packages and the like. Verification of identity can include using one-time codes to verify identity of a device, and/or exchanges of network addresses of devices. Indeed, in some implementations, verification of identity can include verifying that a given device has a given network address. In other implementations, verifying identity can include verifying that a given device is a device registered with a remote computing device. In yet further implementations, verifying identity can include verifying that data was uniquely generated by a given device. Furthermore, applying the techniques herein to mobile devices can be particularly useful as identities of mobile devices can easily be spoofed. In addition, identity verification can be used to trigger transactions that occur without transfer of sensitive account information over communication networks as part of the transaction. In some implementations, identity verification can occur when a device whose identity is being verified is off-line. Further provided herein is a secure keypad that can be rendered at a touch screen display to receive a password and/or a PIN, which can be used to prevent password cracking by using data sets in place of password data when transmitting passwords between devices.

Furthermore, while different implementations of device 105, device 1605, device 2005, device 2205 and device 2605 have been described, in some implementations, functionality of each of device 105, device 1605, device 2005, device 2205 and device 2605 can be combined in one device, including but not limited to a server, which can verify identity of both smart phones and non-smart phones and/or process transactions between accounts associated with smart phones and merchant devices, accounts associated with non-smart phones and merchant devices, and between accounts associated with peers (including, but not limited to transactions between accounts associated with smart phones, transactions between accounts associated with non-smart phones, and transactions between accounts associated with smart phones and non-smart phones). Similarly, functionality described with references to devices 101, 1601, 2001, 2201, 2213, 2601 and 2613 can be combined into one device, including, but not limited to, a mobile device. Similarly, functionality described with references to devices 103, 1603, 2003 and 2003 can be combined into one device, including, but not limited to, a tablet device, a merchant device and the like.

Those skilled in the art will appreciate that in some implementations, the functionality of devices 101, 103, 105, 1601, 1603, 1605, 2001, 2003, 2005, 2201, 2205, 2213, 2601, 2605, 2613, 2614 can be implemented using pre-programmed hardware or firmware elements (e.g., application specific integrated circuits (ASICs), electrically erasable programmable read-only memories (EEPROMs), etc.), or other related components. In other implementations, the functionality of devices 101, 103, 105, 1601, 1603, 1605, 2001, 2003, 2005, 2201, 2205, 2213, 2601, 2605, 2613, 2614 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative implementations and modifications possible, and that the above examples are only illustrations of one or more implementations. The scope, therefore, is only to be limited by the claims appended hereto.

1-56. (canceled)

57. A device comprising:
a processor, a display, a memory and a communication interface, the processor configured to:
receive, from a remote computing device using the communication interface, identifier data;
generate a machine-readable verification code using a first given algorithm, the first given algorithm configured to encode the identifier data in the verification code; data encoded in the verification code being extractable from the verification code using a second given algorithm complimentary to the first given algorithm;
provide the verification code for acquisition by a proximal device for transmission to the remote computing device to provide a one-time verification of the device by extracting at least the identifier data from the verification code using the second given algorithm at the remote computing device; and,
receive, from the remote computing device using the communication interface, new identifier data to generate a new verification code when the verification code expires after one or more of a given time period and a given number of uses.

58. The device of claim 57, wherein the processor is further configured to provide the verification code by one or more of: rendering the verification code at the display; and transmitting the verification code in a near field signal to the proximal device.

59. The device of claim 57, wherein the verification code comprises one or more of: a QR (Quick Response) code, a UPC (Universal Product Code), a graphic, an icon, and a symbol.

60. The device of claim 57, wherein the data encoded in the verification code is extractable from the verification code at the remote computing device using only the second given algorithm.

61. The device of claim 57, wherein the first given algorithm is further configured to encode, in the verification code, one or more of: a device identifier stored at the memory; and a time stamp from a clock device, the device further comprising the clock device.

62. The device of claim 57, wherein the first given algorithm is further configured to: generate a one-time identifier of the device each time the verification code is generated, and encode the one-time identifier in the verification code, the second given algorithm further configured to extract the one-time identifier from the verification code and confirm that the one-time identifier was generated by the device.

63. The device of claim 57, wherein the processor is further configured to generate the one-time-use machine-readable verification code when the device is off-line.

64. The device of claim 57, further comprising an input device, and processor is further configured to request, from a remote computing device, the identifier data when password data is received at the input device.

65. The device of claim 57, wherein the identifier data expires after one or more of the given time period and the given number of uses.

66. The device of claim 57, wherein the verification code is generated in conjunction with one or more of a: further transaction between the proximal device and remote computing device, an exchange of payment data between the proximal device and remote computing device, and an exchange of loyalty plan data between the proximal device and remote computing device.

67. A method comprising:
at a device comprising: a processor, a display, a memory and a communication interface:
receiving, at the processor, from a remote computing device using the communication interface, identifier data;
generating, at the processor, a machine-readable verification code using a first given algorithm, the first given algorithm configured to encode the identifier data in the verification code: data encoded in the verification code being extractable from the verification code using a second given algorithm complimentary to the first given algorithm;
providing, using the processor, the verification code for acquisition by a proximal device for transmission to the remote computing device to provide a one-time verification of the device by extracting at least the identifier data from the verification code using the second given algorithm at the remote computing device; and,
receiving, at the processor, from the remote computing device using the communication interface, new identifier data to generate a new verification code when the verification code expires after one or more of a given time period and a given number of uses.

68. The method of claim 67, further comprising providing the verification code by one or more of: rendering the verification code at the display; and transmitting the verification code in a near field signal to the proximal device.

69. The method of claim 67, wherein the verification code comprises one or more of: a QR (Quick Response) code, a UPC (Universal Product Code), a graphic, an icon, and a symbol.

70. The method of claim 67, wherein the data encoded in the verification code is extractable from the verification code at the remote computing device using only the second given algorithm.

71. The method of claim 67, wherein the first given algorithm is further configured to encode, in the verification code, one or more of: a device identifier stored at the memory; and a time stamp from a clock device, the device further comprising the clock device.

72. The method of claim 67, wherein the first given algorithm is further configured to: generate a one-time identifier of the device each time the verification code is generated, and encode the one-time identifier in the verification code, the second given algorithm further configured to extract the one-time identifier from the verification code and confirm that the one-time identifier was generated by the device.

73. The method of claim 67, further comprising generating the one-time-use machine-readable verification code when the device is off-line.

74. The method of claim 67, wherein the device further comprises an input device, and the method further comprises requesting, from a remote computing device, the identifier data when password data is received at the input device.

75. The method of claim 67, wherein the identifier data expires after one or more of the given time period and the given number of uses.

76. The method of claim 67, wherein the verification code is generated in conjunction with one or more of a: further transaction between the proximal device and remote computing device, an exchange of payment data between the proximal device and remote computing device, and an exchange of loyalty plan data between the proximal device and remote computing device.
